(19) United States
(12) Patent Application Publication
(10) Pub. No.: US 2003/0008563 A1
(43) Pub. Date: Jan. 9, 2003

(54) Interface device and usb interface device for electronic equipment and electronic equipment with interface mechanism

(76) Inventors: Atsushi Nishio, Mito-shi (JP); Katsuhiro Hori, Mito-shi (JP); Satoru Karahashi, Mito-shi (JP); Yoshiyuki Kikuchi, Mito-shi (JP)

Correspondence Address: LADAS & PARRY, 224 SOUTH MICHIGAN AVENUE, SUITE 1200, CHICAGO, IL, 60604, US

(21) Appl. No.: 10/049,078

(22) PCT Filed: Jun. 6, 2001
(86) PCT No.: PCT/JP01/04785

(30) Foreign Application Priority Data
Jun. 7, 2000 (JP) 2000-171141

(51) Int. Cl. H01R 13/40

(52) U.S. Cl. 439/625

(57) ABSTRACT

The present invention relates to a USB interface device allowing a variety of peripheral devices including USB hubs connected through USB interfaces to be connected thereto without using cables. The USB interface device includes a first-type connector provided to a first surface of a case and/or a second-type connector provided to a second surface of the case opposing the first surface, and a USB hub circuit provided in the case so as to connect the connectors, wherein the first-type and second-type connectors are connectable to each other, and the first-type connector of the USB interface device is connected to the second-type connector of another USB interface device and the second-type connector of the USB interface device is connected to the first-type connector of yet another USB interface device when a plurality of USB interface devices are layered one over another.

### TECHNICAL FIELD

The present invention relates to connector devices for electronic devices, USB interface devices, and electronic devices with joining mechanisms, and more particularly to a connector device for an electronic device for electrically or mechanically connecting USB-interface electronic devices in the case of using the electronic devices in a layered structure, a USB interface device, and an electronic device with a joining mechanism.

### BACKGROUND ART

Recently, interfaces of the USB standard (hereinafter referred to as USB interfaces) have been employed in, for instance, personal computers as common interfaces for connecting a variety of peripheral devices such as keyboards, mouse, and printers to personal computer main bodies.

A USB hub (electronic device) having a plurality of connectors of a USB interface is used to connect a plurality of peripheral devices having the USB interface to a personal computer main body.

Here, the USB interface employs a cable that is an assembly of two signal lines and two power supply lines so that electricity can be supplied from each USB port to the peripheral devices via the USB hub.

Such a USB hub has a configuration as shown in FIG. 1.

In FIG. 1, a USB hub 1 is composed of a first USB port 3 formed of one USB connector and provided to a case 2, second USB ports 4 formed of a plurality of (four in the drawing) USB connectors and provided to the case 2, and a USB hub circuit 5 provided in the case 2. The first USB port 3 is connected to the host side of the USB hub circuit 5 and each of the second USB ports 4 is connected to the lower side of the USB hub circuit 5.

According to the USB hub 1 of this configuration, as shown in FIG. 2, a personal computer PC is connected to the first USB port 3 and at the same time a keyboard 6, a mouse 7, a printer 8, and a scanner 9 that support the USB are connected to the second USB ports 4.

Thereby, the keyboard 6, the mouse 7, the printer 8, and the scanner 9 that support the USB and are connected via the USB hub 1 to the personal computer PC are operable therefrom.

Further, by hierarchically connecting such USB hubs 1, 127 peripheral devices can be used in six layers, for instance. Since the peripheral devices may be connected hot-line (so-called hot plugging), the convenience of personal computers is further increased.

According to the USB hub 1, each of the USB-interface peripheral devices is connected to the USB hub 1 by a cable, and the USB hub 1 is connected to the personal computer main body by a cable.

Accordingly, a plurality of cables are connected to the USB hub 1, causing a problem that space for the cables is required around the USB hub 1 and the cables get complicated.

As a means to solve this problem, it can be proposed to superimpose a plurality of USB hubs into a layered structure by taking advantage of the hierarchical connectability of the USB hubs. This structure allows a large number of cables to be connected to the USB hubs in a small space. At this point, operability is decreased if the superposed USB hubs are moved when the cables are attached thereto or detached therefrom. Therefore, it is necessary to prevent the superposed USB hubs from being moved with respect to each other.

### DISCLOSURE OF THE INVENTION

A general object of the present invention is to provide in which the above-described disadvantages of the prior art are eliminated.

A more specific object of the present invention is to realize a USB interface device allowing a variety of peripheral devices including USB hubs connected through USB interfaces to be connected thereto with using cables.

Another object of the present invention is to reliably stack a plurality of electronic devices in layers with a simple configuration.

The above objects of the present invention are achieved, according to a first configuration of the present invention, by a connector device for an electronic device electrically connecting a plurality of electronic devices when the electronic devices are layered one over another, the connector device for an electronic device including a first-type connector provided to a first surface of a case of each of the electronic devices, a second-type connector provided in a position on a second surface opposing the first surface, the position corresponding to a position in which the first-type connector is provided, wherein at least one of the first-type and second-type connectors provided to one of the layered electronic devices is connected to the connector provided to another one of the layered electronic devices when the electronic devices are layered one over another, the connector being of a type different from that of the one of the first-type and second-type connectors.

The above objects of the present invention are also achieved, according to a second configuration of the present invention, by a USB interface device including a first-type connector provided to a first surface of a case, a second-type connector provided to a second surface of the case opposing the first surface, and a USB hub circuit provided in the case so as to connect the connectors, wherein the first-type and second-type connectors are connectable to each other, and the first-type connector of the USB interface device is connected to the second-type connector of another USB interface device and the second-type connector of the USB interface device is connected to the first-type connector of yet another USB interface device when a plurality of USB interface devices are layered one over another for connection.

The above objects of the present invention are also achieved, according to a third configuration of the present invention, by a USB interface device including a first-type connector provided to a first surface of a case and a USB device part connected to the first-type connector, wherein the first-type connector of the USB interface device is connected to a second-type connector of another USB interface device when the other USB interface device is layered on the first surface for connection.

The above objects of the present invention are also achieved, according to a fourth configuration of the present invention, by a USB interface device including a second-type connector provided to a second surface of a case, a host-side USB port provided in the case, and a USB hub circuit provided in the case so as to connect the connector and the USB port, wherein the second-type connector and a first-type connector provided to a first surface of a case of another USB interface device are connectable to each other, and the second-type connector of the USB interface device is connected to the first-type connector of the other USB interface device when the other USB interface device is layered on the second surface for connection.

Additionally, in the USB interface device according to the present invention, it is preferable that the first-type connector be a terminal part formed on a substrate provided in the case and exposed in a window part provided to the first surface of the case, the second-type connector be a contact part protruding from the second surface of the case, and the terminal part and the contact part come into contact with each other at a time of connection so as to be electrically connected.

Additionally, in the USB interface device according to the present invention, it is preferable that the first-type connector be a contact part protruding from the first surface of the case, the second-type connector be a terminal part formed on a substrate provided in the case and exposed in a window part provided to the second surface of the case, and the terminal part and the contact part come into contact with each other at a time of connection so as to be electrically connected.

Additionally, the USB interface device according to the present invention preferably includes rib holders provided on both sides of the window part exposing the terminal part, the rib holders protruding inwardly toward each other, and ribs provided on both sides of the contact part, the ribs protruding outwardly, wherein the ribs preferably engage the rib holders so that the terminal part and the contact part are positioned relative to each other.

Additionally, in the USB interface device according to the present invention, it is preferable that a cover be attached to the rib holders so as to cover the window part when the terminal part is unused.

Additionally, in the USB interface device according to the present invention, it is preferable that the contact part be supported rotatably with respect to the case and the contact part be rotated with respect to the case to be housed therein when the contact part is unused.

Additionally, the USB interface device according to the present invention preferably includes an engaging concave part or an engaging convex part provided to the first surface having the first-type connector and an engaging convex part or an engaging concave part provided to the second surface having the second-type connector, wherein the engaging convex part preferably engages the engaging concave part at a time of connection.

Additionally, the USB interface device according to the present invention preferably includes a guide groove extending in one direction or a guiding convex part provided to the first face having the first-type connector and a guiding convex part or a guide groove extending in one direction, wherein the guiding convex part preferably slides inside the guide groove at the time of connection so that positions of the USB interface devices are restricted in a sideward direction perpendicular to the one directions and the engaging convex part preferably engages the engaging concave part at a sliding end position.

Additionally, the USB interface device according to the present invention preferably includes an engaging concave part or an engaging convex part for positioning provided to the first surface having the first-type connector and an engaging convex part or an engaging concave part for positioning provided to the second surface having the second-type connector, wherein the USB interface devices are preferably half-locked to each other at the time of connection by the convex part engaging the concave part with the engaging convex part engaging the engaging concave part.

Additionally, the USB interface device according to the present invention preferably includes at least one USB port provided to an outer surface of the case, the USB port being connected to the USB hub circuit.

Additionally, in the USB interface device according to the present invention, the USB device part may be an auxiliary storage device.

Additionally, in the USB interface device according to the present invention, the USB device part may be a USB port.

Additionally, in the USB interface device according to the present invention, the USB device part may be a power-supply battery.

The above objects of the present invention are also achieved, according to a fifth configuration of the present invention, by an electronic device with a joining mechanism mechanically joining a plurality of electronic devices when the electronic devices are layered one over another, wherein the joining mechanism includes a convex part provided to a case of one of the electronic devices and a concave part provided to a surface of a case of another one of the electronic devices, the surface opposing a surface of the case of the one of the electronic devices to which surface the concave part is provided when the other one of the electronic devices is layered on the one of the electronic devices, the concave part engaging the convex part to mechanically join the one and the other one of the electronic devices.

Additionally, in the electronic device with the joining mechanism according to the present invention, it is preferable that the convex part and the concave part be provided on a surface of a case of the electronic device in symmetrical positions with respect to a center position of the surface of the case.

Additionally, in the electronic device with the joining mechanism according to the present invention, it is preferable that the convex part be movable with respect to a case of the electronic device and be moved between a protruding position at which the convex part protrudes from a surface of the case and a housed position at which the convex part is housed without protruding from the surface of the case.

Additionally, in the electronic device with the joining mechanism according to the present invention, it is preferable that the convex part engage the concave part by sliding the one of the electronic devices relative to the other one of the electronic devices.

Additionally, in the electronic device with the joining mechanism according to the present invention, it is preferable that at least one of the convex part and the concave part have a hook-like shape.

Additionally, in the electronic device with the joining mechanism according to the present invention, it is preferable that a projection part be formed on the convex part so as to protrude toward the outside of the case at the protruding position.

Additionally, in the electronic device with the joining mechanism according to the present invention, it is preferable that the electronic apparatus be a USB interface device having a USB port provided thereto.

The above-described invention has the following effects.

According to the first configuration, with a plurality of electronic devices being layered one over another, a first-type connector provided to a case surface of one electronic device and a second-type connector provided to a case surface of another electronic device which case surface opposes the case surface of the one electronic device are connected to each other so that the layered electronic devices are electrically connected to each other successively with the first-type and second-type connectors.

Further, according to the second configuration, with a plurality of USB interface devices being layered one over another, a first-type connector provided to a first surface of one USB interface device and a second-type connector provided to a second surface of an adjacent USB interface device are connected to each other so that the USB interface devices are successively connected to each other.

According to the third configuration, the USB interface device of this configuration and the USB interface device according to the first configuration or to the later-described third configuration are layered one over the other so that the first-type connector provided to the first surface of the USB interface device of this configuration and the second-type connector provided to the second surface of the adjacent USB interface device of the first or second configuration are connected to each other, thereby the USB interface devices are successively connected to each other.

Further, according to the fourth configuration, the USB interface device of this configuration and the USB interface device according to the first or second configuration are layered one over the other so that the first-type connector provided to the first surface of the USB interface device of the first or third configuration and the second-type connector provided to the second surface of the adjacent USB interface device of this configuration are connected to each other, thereby the USB interface devices are successively connected to each other.

As described above, the electronic devices or USB interface devices according to the first through fourth configurations are directly connectable to each other without using cables. Thereby, space for cables for connection is dispensed with, and connections can be made by efficiently simplified interconnection lines.

Further, in the case where the first-type connector is a terminal part formed on a substrate provided inside a case and exposed in a window part provided to a first surface of the case and the second-type connector is a contact part protruding from a second surface of the case so that the terminal part and the contact part are electrically connected by contacting each other at a time of connection, a terminal part of the first-type connector contacts a contact part of the second-type connector so that the first-type connector provided to a first surface of one USB interface device and the second-type connector provided to a second surface of an adjacent USB interface device are electrically connectable to each other.

Further, in the case where the first-type connector is a contact part protruding from a first surface of a case and the second-type connector is a terminal part formed on a substrate provided inside the case and exposed in a window part provided to a second surface of the case so that the terminal part and the contact part are electrically connected by contacting each other at a time of connection, a contact part of the first-type connector contacts a terminal part of the second-type connector so that the first-type connector provided to a first surface of one USB interface device and the second-type connector provided to a second surface of an adjacent USB interface device are electrically connectable to each other.

Further, in the case where rib holders are provided on both sides of the window part exposing the terminal part, the rib holders protruding inwardly toward each other, and ribs are provided on both sides of the contact part so as to protrude outwardly, the ribs engaging the rib holders so that the terminal part and the contact part are positioned relative to each other, the terminal part and the contact part can be positioned relative to each other with ease and accuracy by the ribs engaging the rib holders.

Further, in the case where a cover is attached to the rib holders to cover the window part when the terminal part is unused, the window part is covered with the cover so that the unused terminal part is retracted in the case for protection.

Further, in the case where the contact part is supported rotatably with respect to the case and the contact part is rotated with respect to the case to be housed therein when the contact part is unused, the contact part is rotated to be housed in the case for protection.

Further, in the case where an engaging concave part or an engaging convex part is provided to a first surface having the first-type connector and an engaging convex part or an engaging concave part is provided to a second surface having the second-type connector, the engaging convex part engaging the engaging concave part at a time of connection, the engaging convex part and the corresponding concave part engage each other so that cases of a plurality of USB interface devices can be securely fixed to and held by each other.

Further; in the case where a guide groove extending in one direction or a guiding convex part is provided to a first surface having the first-type connector and a guiding convex part or a guide groove extending in one direction is provided to a second surface having the second-type connector, the guiding convex part sliding inside the guide groove at a time of connection so that positions of USB interface devices are restricted in a sideward direction perpendicular to the one directions and the engaging convex part engages the engaging concave part at a sliding end position, the guiding convex part slides inside the guide groove so that the cases of the USB interface devices can be guided to a fixing position by the engaging convex part and the engaging concave part without being shifted to sideward positions relative to each other.

Further, in the case where a convex part or a concave part for positioning is provided to a first surface having the first-type connector and a concave part or a convex part for positioning is provided to a second surface having the second-type connector, the convex part engaging the concave part at a time of connection with the engaging convex part engaging the engaging concave part so that USB interface devices are half-locked to each other, the convex part engages the concave part so that the cases of the USB interface devices can be positioned relative to each other in the fixing position.

Further, if a USB interface device has at least one USB port provided to an outer surface of its case and connected to a USB hub circuit, the USB interface device can be used in the same way as the conventional USB hub device.

Further, if the USB device part is an auxiliary storage device, a variety of peripheral devices such as a compact flash card and a memory stick of a USB interface standard can be USB-connected directly by the case.

Further, if the USB device part is a USB port, a variety of peripheral devices of various USB interfaces can be connected to the USB port of the USB interface device through cables as in the conventional way.

Further, if the USB device part is a power-supply battery, power is supplied from the power-supply battery via the first-type connector and the second-type connector of a USB interface device to the USB interface device and further to the other successively connected USB interface devices.

Additionally, according to the fifth configuration, a joining mechanism mechanically joining a plurality of electronic devices includes a convex part provided to a case of one electronic device and a concave part provided to a case surface of another electronic device, the case surface opposing a surface of the case of the one electronic device which surface having the convex part formed thereon when the other electronic device is layered on the one electronic device, the convex part engages the concave part so that the one and the other electronic devices are mechanically joined. Therefore, the one and the other electronic devices can be joined in a layered state with a simple configuration. Further, compared with a configuration where a plurality of electronic devices are provided in a planar arrangement, space reduction can be realized. Furthermore, compared with a configuration where electronic devices are simply layered one over another, the electronic devices are prevented from having a deviation between their positions.

Additionally, with the convex part and the concave part being provided to the same case surface of an electronic device in symmetrical positions with respect to a center position of the case surface, simply by reversing one electronic device with respect to another electronic device so that case surfaces thereof on which the convex parts and the concave parts are formed oppose each other, the convex part of the one electronic device can be engaged with the concave part of the other electronic device and the concave part of the one electronic device can be engaged with the convex part of the other electronic device.

Additionally, with the convex part being movable with respect to a case of an electronic apparatus so as to be moved between a protruding position at which the convex part protrudes from a case surface and a housed position at which the convex part is housed without protruding from the case surface, the convex part is prevented from protruding from the case when the convex part is unused. This increases portability.

Additionally, with the convex part being rotatable with respect to the case of the electronic device so as to be movable with respect to the case of the electronic device, space for the movement of the concave part can be reduced and the electronic device can be downsized compared with a configuration where the convex part is moved linearly. Further, compared with a configuration where the convex part slides on a line, an operation of shifting the convex part to the protruding position can be performed with ease.

Additionally, with the convex part engaging the concave part by sliding one electronic device relative to another electronic device, an operator can engage the convex part with the concave part while holding the electronic devices. Therefore, an engagement operation can be facilitated.

Additionally, with at least one of the convex part and the concave part shaped like a hook, the engaging force of the convex part and the concave part at the time of their engagement can be increased. Thereby, electronic devices can be maintained reliably in a layered state.

Additionally, by forming a projection part on the convex part which projection part protrudes toward the outside of the case at the protruding position, an inward force is exerted on the convex part when the convex part engages the concave part. This prevents the convex part from falling toward the housed position at the time of the engagement.

Additionally, in the case where the electronic device is applied to a USB interface device having a USB port provided thereto, multiple interconnection lines can be simplified efficiently to be connected to the USB interface device.

### BRIEF DESCRIPTION OF THE DRAWINGS

Other objects, features, and advantages of the present invention will become more apparent from the following detailed description when read in conjunction with the accompanying drawings, in which:

FIG. 1 is a block diagram showing a conventional USB hub;

FIG. 2 is a schematic diagram showing a use of the USB hub of FIG. 1;

FIG. 3 is a schematic front view of a joined USB interface system including a USB interface device that is a first embodiment of the present invention;

FIG. 4 is a schematic front view of the USB interface system of FIG. 3 in a pre-joined state;

FIG. 5(A) is a plan view of the USB interface device (an electronic device) employed in the USB interface system of FIG. 3;

FIG. 5(B) is a front view of the USB interface device (the electronic device) employed in the USB interface system of FIG. 3;

FIG. 5(C) is a bottom view of the USB interface device (the electronic device) employed in the USB interface system of FIG. 3;

FIG. 6(A) is a rear view of the USB interface device of FIG. 5;

FIG. 6(B) is a right side view of the USB interface device of FIG. 5;

FIG. 6(C) is a sectional view taken along a line A-A of FIG. 5;

FIG. 6(D) is a sectional view taken along a line B-B of FIG. 5;

FIG. 6(E) is a sectional view taken along a line C-C of FIG. 5;

FIG. 7(A) is a perspective view of the USB interface device of FIG. 5 taken from its rear upper right;

FIG. 7(B) is a perspective view of the USB interface device of FIG. 5 taken from its front upper right;

FIG. 8(A) is a perspective view of the USB interface device of FIG. 5 taken from its rear lower right;

FIG. 8(B) is a perspective view of the USB interface device of FIG. 5 taken from its front lower right;

FIG. 9(A) is a front view of a contact part of the USB interface device of FIG. 5;

FIG. 9(B) is a right side view of the contact part of the USB interface device of FIG. 5;

FIG. 9(C) is a sectional view of the contact part of the USB interface device of FIG. 5 taken along a line D-D;

FIG. 9(D) is a sectional view of the contact part of the USB interface device of FIG. 5 in a state where contacts are elastically deformed;

FIG. 10 is a diagram for illustrating an assembly of the contact part of FIG. 9;

FIGS. 11(A) through 11(D) are sequential sectional views of the contact part of FIG. 9 rotated from a contact extraction state to a contact retraction state;

FIGS. 12(A) through 12(C) are sequential perspective views of the contact part of FIG. 9 rotated from the contact extraction state to the contact retraction state;

FIG. 13(A) is a plan view of the USB interface device with the contact part being in the contact retraction state;

FIG. 13(B) is a front view of the USB interface device with the contact part being in the contact retraction state;

FIG. 14(A) is a perspective view of the USB interface device of FIG. 5 without a cover for a terminal part;

FIG. 14(B) is a perspective view of the USB interface device of FIG. 5 without a cover for a terminal part;

FIG. 15 is a fragmentary bottom view of the USB interface device of FIG. 5 without a cover for a terminal part;

FIG. 16(A) is a perspective view of a USB interface device that is a second embodiment of the present invention taken from its rear upper right;

FIG. 16(B) is a perspective view of the USB interface device that is the second embodiment of the present invention taken from its front upper right;

FIG. 17(A) is a perspective view of the USB interface device of FIG. 16 taken from its rear lower right;

FIG. 17(B) is a perspective view of the USB interface device of FIG. 16 taken from its front lower right;

FIG. 18(A) is a perspective view of a USB interface device that is a third embodiment of the present invention taken from its rear upper right;

FIG. 18(B) is a perspective view of the USB interface device that is the third embodiment of the present invention taken from its front upper right;

FIG. 19(A) is a perspective view of the USB interface device of FIG. 18 taken from its rear lower right;

FIG. 19(B) is a perspective view of the USB interface device of FIG. 18 taken from its front lower right;

FIG. 20(A) is a perspective view of a USB interface device that is a fourth embodiment of the present invention taken from its front upper right;

FIG. 20(B) is a perspective view of the USB interface device that is the fourth embodiment of the present invention taken from its rear upper right;

FIG. 21(A) is a perspective view of a USB interface device that is a variation of the third embodiment of the present invention taken from its rear upper right;

FIG. 21(B) is a perspective view of the USB interface device that is the variation of the third embodiment of the present invention taken from its front upper right;

FIG. 22(A) is a perspective view of the USB interface device of FIG. 21 taken from its rear lower right;

FIG. 22(B) is a perspective view of the USB interface device of FIG. 21 taken from its front lower right;

FIG. 23(A) is a right side view of the USB interface device shown in FIGS. 5 through 8 and the USB interface device shown in FIGS. 16 and 17 in a pre-joined state;

FIG. 23(B) is a sectional view taken along hook holes of the USB interface device shown in FIGS. 5 through 8 and the USB interface device shown in FIGS. 16 and 17 in the pre-joined state;

FIG. 23(C) is a sectional view taken along a terminal part of the USB interface device shown in FIGS. 5 through 8 and the USB interface device shown in FIGS. 16 and 17 in the pre-joined state;

FIG. 23(D) is a sectional view taken along a guide groove of the USB interface device shown in FIGS. 5 through 8 and the USB interface device shown in FIGS. 16 and 17 in the pre-joined state;

FIG. 24(A) is a right side view of the USB interface device shown in FIGS. 5 through 8 and the USB interface device shown in FIGS. 16 and 17 in a contacted state;

FIG. 24(B) is a sectional view taken along the hook holes of the USB interface device shown in FIGS. 5 through 8 and the USB interface device shown in FIGS. 16 and 17 in the contacted state;

FIG. 24(C) is a sectional view taken along the terminal part of the USB interface device shown in FIGS. 5 through 8 and the USB interface device shown in FIGS. 16 and 17 in the contacted state;

FIG. 24(D) is a sectional view taken along the guide groove of the USB interface device shown in FIGS. 5 through 8 and the USB interface device shown in FIGS. 16 and 17 in the contacted state;

FIG. 25(A) is a right side view of the USB interface device shown in FIGS. 5 through 8 and the USB interface device shown in FIGS. 16 and 17 in a joined state;

FIG. 25(B) is a sectional view taken along the hook holes of the USB interface device shown in FIGS. 5 through 8 and the USB interface device shown in FIGS. 16 and 17 in the joined state;

FIG. 25(C) is a sectional view taken along the terminal part of the USB interface device shown in FIGS. 5 through 8 and the USB interface device shown in FIGS. 16 and 17 in the joined state;

FIG. 25(D) is a sectional view taken along the guide groove of the USB interface device shown in FIGS. 5 through 8 and the USB interface device shown in FIGS. 16 and 17 in the joined state;

FIG. 26(A) is a plan view of a USB interface device that is a fifth embodiment of the present invention;

FIG. 26(B) is a left side view of the USB interface device that is the fifth embodiment of the present invention;

FIG. 26(C) is a front view of the USB interface device that is the fifth embodiment of the present invention;

FIG. 26(D) is a right side view of the USB interface device that is the fifth embodiment of the present invention;

FIG. 26(E) is a rear view of the USB interface device that is the fifth embodiment of the present invention;

FIG. 26(F) is a bottom view of the USB interface device that is the fifth embodiment of the present invention;

FIG. 27 is a sectional view taken along a line A-A of FIG. 26;

FIG. 28(A) is a plan view of a case half body forming the USB interface device that is the fifth embodiment of the present invention;

FIG. 28(B) is a left side view of the case half body forming the USB interface device that is the fifth embodiment of the present invention;

FIG. 28(C) is a front view of the case half body forming the USB interface device that is the fifth embodiment of the present invention;

FIG. 28(D) is a right side view of the case half body forming the USB interface device that is the fifth embodiment of the present invention;

FIG. 28(E) is a rear view of the case half body forming the USB interface device that is the fifth embodiment of the present invention;

FIG. 28(F) is a bottom view of the case half body forming the USB interface device that is the fifth embodiment of the present invention; FIG. 29(A) is a plan view of a case half body forming the USB interface device that is the fifth embodiment of the present invention;

FIG. 29(B) is a left side view of the case half body forming the USB interface device that is the fifth embodiment of the present invention;

FIG. 29(C) is a front view of the case half body forming the USB interface device that is the fifth embodiment of the present invention;

FIG. 29(D) is a right side view of the case half body forming the USB interface device that is the fifth embodiment of the present invention;

FIG. 29(E) is a rear view of the case half body forming the USB interface device that is the fifth embodiment of the present invention;

FIG. 29(F) is a bottom view of the case half body forming the USB interface device that is the fifth embodiment of the present invention;

FIG. 30 is an enlarged sectional view in the vicinity of a bearing part of the case half body shown in FIG. 29;

FIG. 31 is an enlarged sectional view in the vicinity of an engaging part of the case half body shown in FIG. 29;

FIGS. 32(A) and 32(B) are diagrams showing a hook part forming the USB interface device that is the fifth embodiment of the present invention on an enlarged scale, the hook part being in a housed position;

FIGS. 33(A) and 33(B) are diagrams showing the hook part forming the USB interface device that is the fifth embodiment of the present invention on an enlarged scale, the hook part being in a state rotated 90° from a state shown in FIG.-32;

FIGS. 34(A) and 34(B) are diagrams showing the hook part forming the USB interface device that is the fifth embodiment of the present invention on an enlarged scale, the hook part being rotated to be in a protruding position;

FIG. 35 is a sectional view of the paired USB interface devices that are the fifth embodiments of the present invention in a pre-joined state;

FIG. 36 is a perspective view of the paired USB interface devices that are the fifth embodiments of the present invention in the pre-joined state; and

FIG. 37 is a sectional view of the paired USB interface devices that are the fifth embodiments of the present invention in a joined state, the USB interface devices forming a USB interface system.

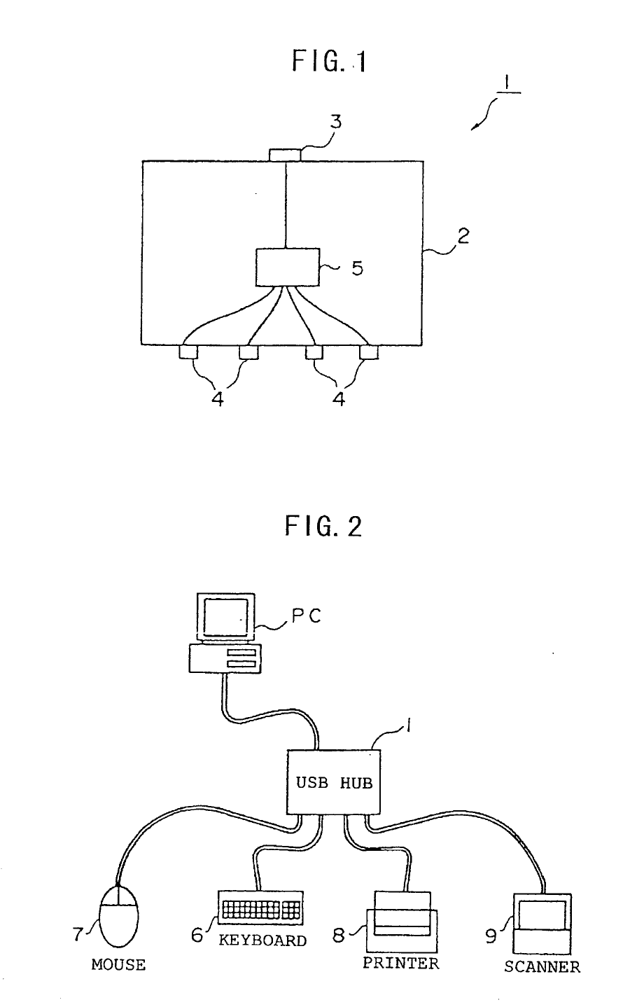

### BEST MODE FOR CARRYING OUT THE INVENTION

Next, a description will be given, with reference to the accompanying drawings, of modes for carrying out the present invention.

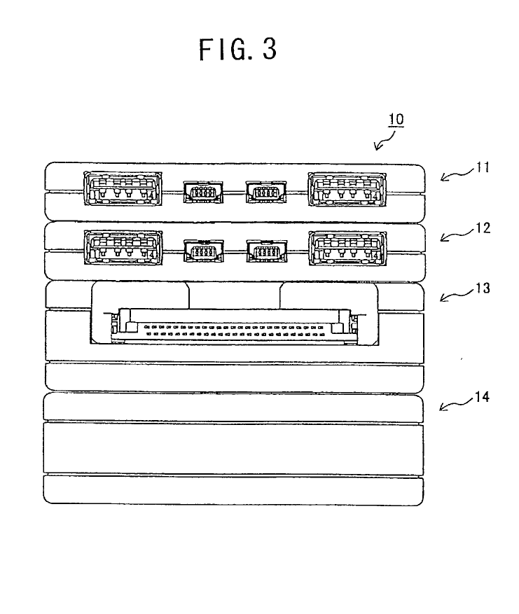

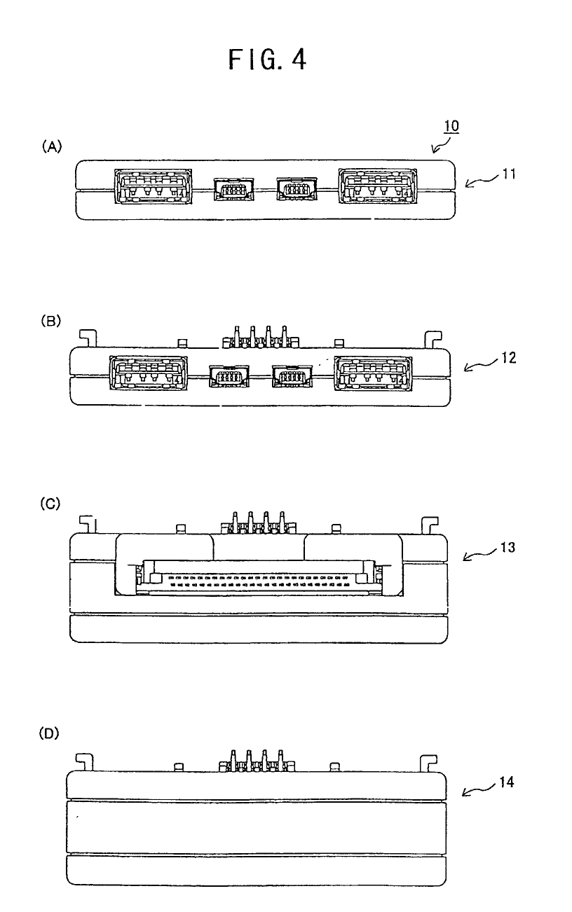

FIGS. 3 and 4 show a multilayer unit composed of a plurality of superposed electronic devices according to the present invention. In this embodiment, a description will be given of a case where USB interface devices are employed as the electronic devices.

FIG. 3 shows a USB interface system 10 formed of a plurality of superposed (layered) USB interface devices 11, 12, 13, and 14 formed according to the present invention. Of the USB interface devices 11, 12, 13, and 14 forming the USB interface system 10, the USB interface device 11 is a first embodiment of the present invention and formed as a so-called main USB hub. The USB interface device 11 is connected to a host such as a personal computer via a USB cable, for instance.

The USB interface device 12 is a second embodiment of the present invention and a so-called option USB hub that is connected to the main USB hub. The USB interface device 13 is a third embodiment of the present invention and a compact flash card reader as an auxiliary storage device. Further, the USB interface device 14 is a fourth embodiment of the present invention and an electric supply battery for the USB interfaces (for instance, a power unit housing a battery).

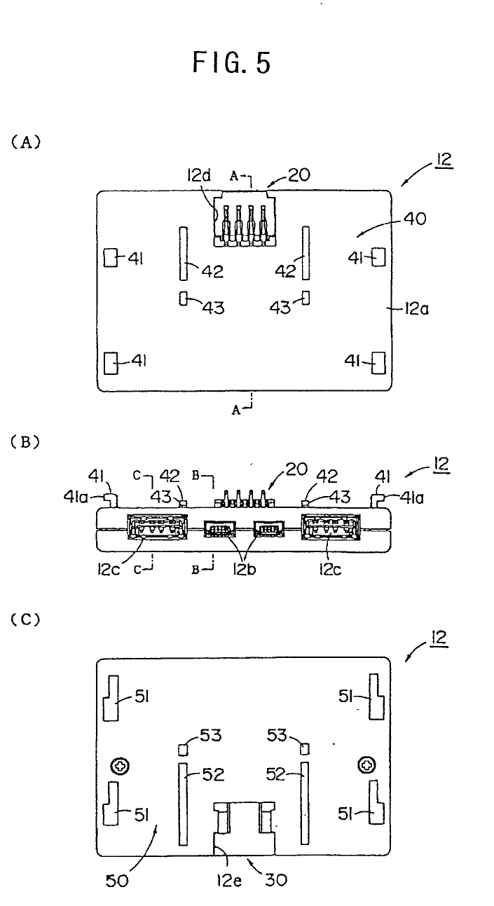

Of the USB interface devices 11, 12, 13, and 14, apart from the topmost USB interface device 11, each of the USB interface devices 12, 13, and 14 has a contact part 20 as a first-type connector provided on its upper surface as a first surface. On the other hand, of the USB interface devices 11, 12, 13, and 14, apart from the bottommost USB interface device 14, each of the USB interface devices 11, 12, and 13 has a terminal part 30 as a second-type connector provided on its lower surface as a second surface (see FIGS. 5(C), 6, 8, 14, and 15).

A description will now be given of the USB interface device 12 with the contact part 20 and the terminal part 30.

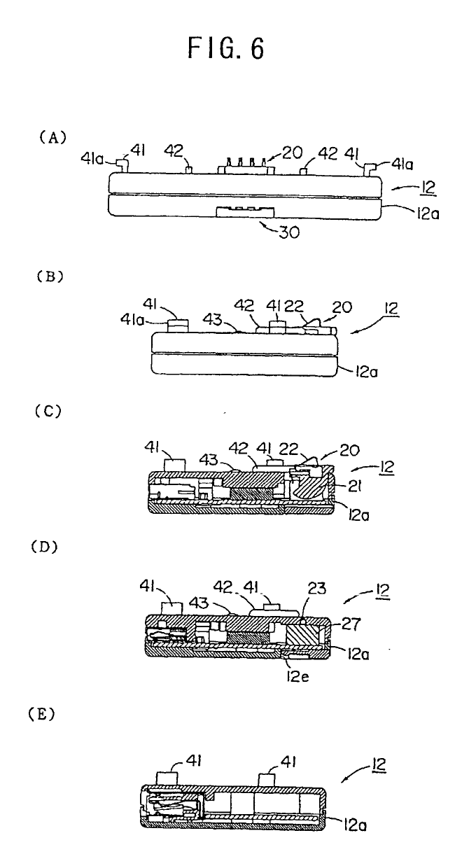

As shown in FIGS. 5 and 6, the USB interface device 12 is formed as a USB hub, and has a case 12a of a flat rectangular parallelepiped shape, the contact part 20 provided on the upper surface of the case 12a, and the terminal part 30 provided on the lower surface of the case 12a.

The contact part 20 is connected, as a so-called host-side USB port, to a chip-shaped USB hub circuit mounted on an internally provided substrate (not shown in the drawings). Further, two types of USB ports 12b and 12c are provided on the front side of the case 12a. The USB ports 12b and 12c and the terminal part 30 are also connected, as lower-side USB ports, to the USB hub circuit.

Further, the USB interface device 12 has connection parts 40 and 50 on the upper and lower surfaces of the case 12a, respectively, for positioning and fixing itself on other USB interface devices.

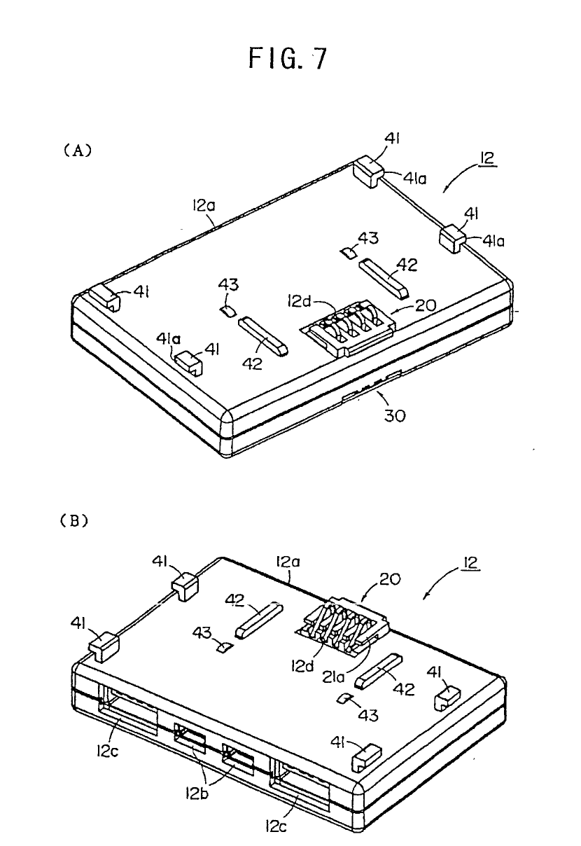

As shown in FIGS. 5(A) and 7, the connection part 40 includes, on the upper surface of the case 12a, two pairs of hooks 41 as engaging convex parts provided close to both side edges, a pair of guiding convex parts pair of positioning convex parts 43 provided on lines extending from sides of the guiding convex parts 42.

The hooks 41 extend upward and then outwardly in reverse-L shapes, forming hook claws 41a. The hooks 41 are formed integrally with the case 12a. The guiding convex parts 42 are formed integrally with the case 12a so as to extend parallel to each other in front and rear directions on the upper surface of the case 12a. Further, the positioning convex parts 43 are formed to have semicircular shapes with a slight height in, for instance, the front and rear directions.

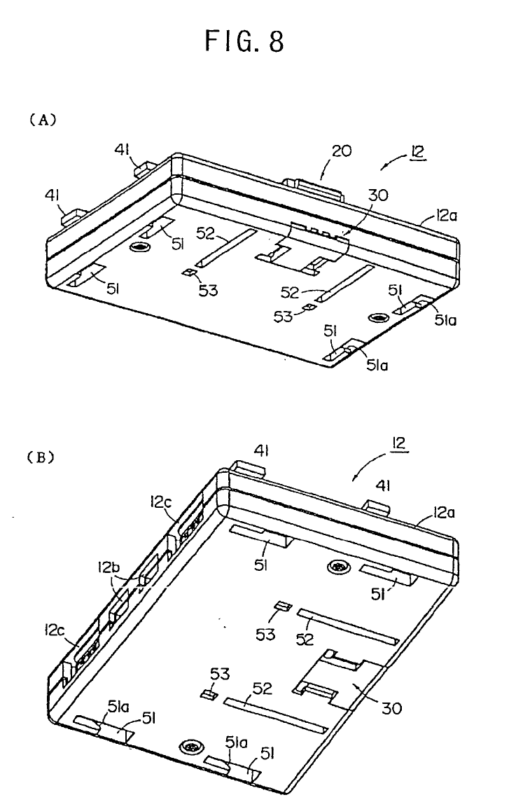

On the other hand, as shown in FIGS. 5(C) and 8, the connection part 50 includes, on the lower surface of the case 12a, two pairs of hook holes 51 provided close to both side edges, a pair of guide grooves 52 provided on both sides of the terminal part 30, and a pair of positioning concave parts 53 provided on lines extending from sides of the guide grooves 52.

The hook holes 51 are provided in positions corresponding to the hooks 41 and extend in the front and rear directions with their rear ends being formed to be wide enough to permit insertion and disengagement of the hook claws 41a and their front ends having a narrow width determined therefor so as to engage the hook claws 41a.

Indentations 51a (see FIG. 8) are formed obliquely in the bottoms of the width-directional steps of the hook holes 51 so as to fix and hold sliding movements of the hook claws 41a with ease and reliability.

The guide grooves 52 are provided in positions corresponding to the guiding convex parts 42 and formed integrally with the case 12a so as to extend parallel to each other in the front and rear directions on the lower surface of the case 12a. Further, the positioning concave parts 53 are provided in positions corresponding to the positioning concave parts 43.

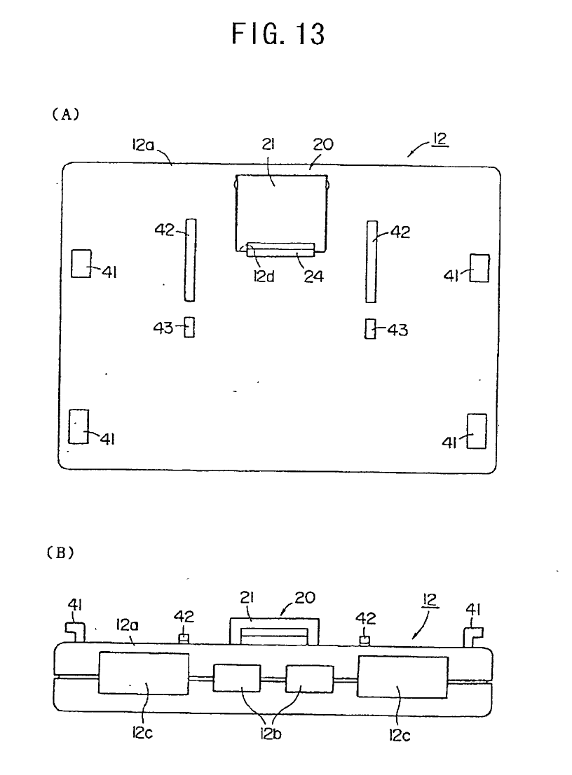

Here, as shown in FIGS. 6(C), 9, 11, 12, and 13, the contact part 20 is composed of a main body 12 rotatably supported with respect to the case 12a, a plurality of (four in the case shown in the drawings) contacts 22 provided parallel to each other on the surface of the main body 21, a rotation shaft 23 protruding from both sides of the main body 21, and an convex part 24 for stopping rotation.

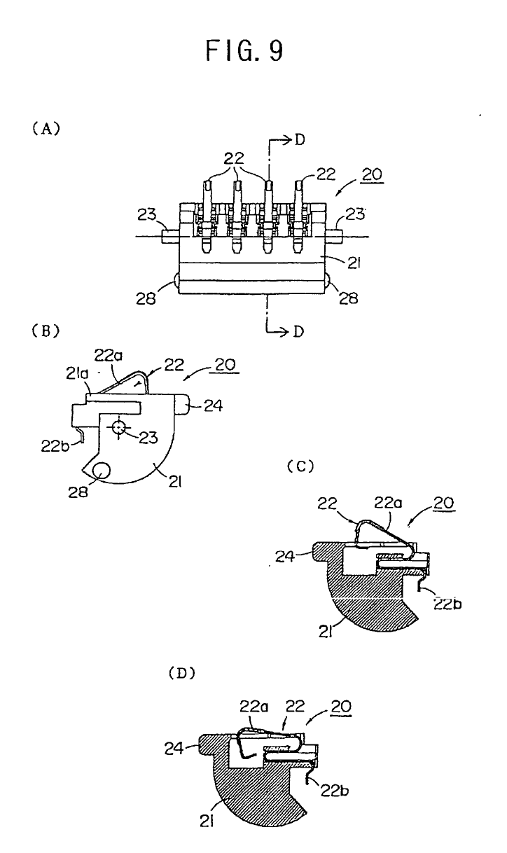

The main body 21 is formed of plastic, for instance, and the contacts 22 are integrally incorporated into the main body 21 by, for instance, insert molding. The contacts 22 are formed of a conductive elastic material Each contact 22 has one end 22a thereof deforming as shown in FIG. 9(D) by elastic deformation in contacting the contact of the terminal part 30 and the other end 22b protruding from the outer side of the main body 21.

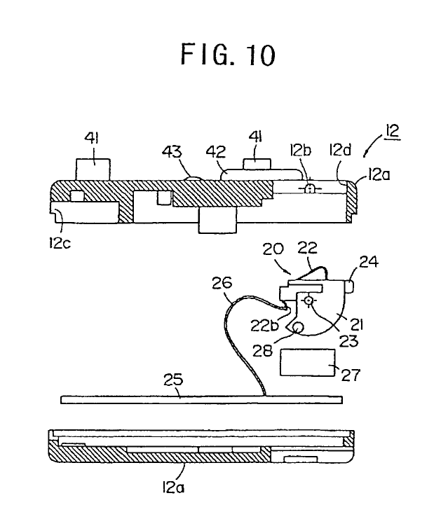

The contact part 20 of this configuration is assembled as shown in FIG. 10 at the time of assembly. That is, after the other end 22b of each contact 22 is electrically connected via a lead line 26 to a connection pattern on a substrate 25 housed in the case 12a, the rotation shaft 23 of the main body 21 of the contact part 20 is inserted into a bearing part 12b provided in the case 12a to be held by a fixing member 27, and the case 12a is closed, thereby completing the assembly of the contact part 20.

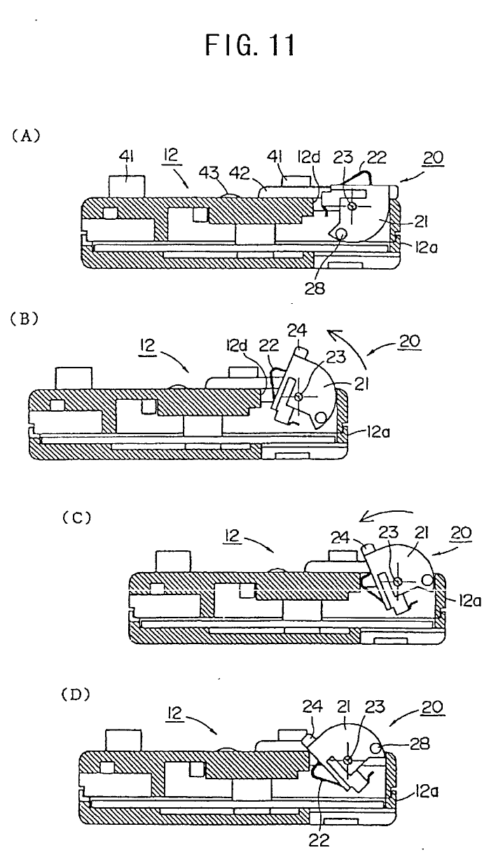

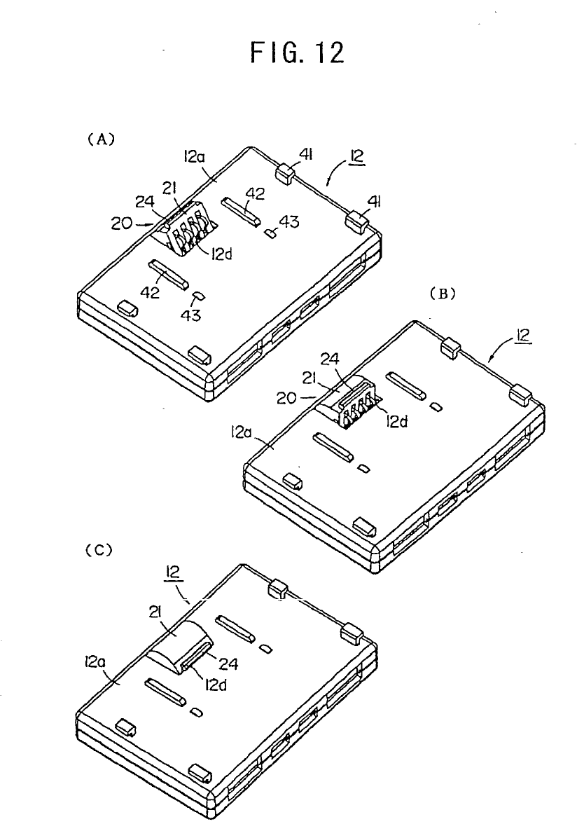

According to the contact part 20 of this configuration, normally (or at the time of using the contact part 20), as shown in FIGS. 7 and 11(A), the contact part 20 is located in a contact extraction position where the contacts 22 are completely extracted from an indentation part 12d provided in the rear end edge of the upper surface of the case 12a. However, by being rotated about the rotation shaft 23 from the contact extraction position, the contact part 20 successively enters a slightly rotated state shown in FIGS. 11(B) and 12(A) and a further rotated state shown in FIGS. 11(C) and 12(B), and finally reaches a contact retraction position as shown in FIGS. 11(D), 12(C), and 13 with the convex part 24 for stopping rotation contacting the front peripheral edge of the indentation part 12d (that is, the case 12a).

The contact part 20 is locked in the contact retraction position with small projections 28 formed on the sides of the main body 21 being engaged with the rear peripheral edge of the indentation part 12d, that is, the surface of the case 12a. Further, in the contact extraction position, the contact part 20 has ribs 21a projecting rightward and leftward on both sides of the upper surface of the main body 21.

On the other hand, the terminal part 30 is composed of a plurality of (four in the case shown in the drawings) terminals 31 formed of conductive patterns formed on the substrate inside the case 12a, a frame 32 formed inside a window part 12e of the case 12a to partition the terminals 31, and a cover 33 that is detachably attached to fill in the window part 12e. The terminal part 30 is configured so as to be exposed inside the window part 12e provided on the rear end edge of the lower surface of the case 12a.

A vertical distance from the lower surface of the case 12a to each terminal 31 is determined to be smaller than a height of the corresponding contact 22 of the contact part 20 from the upper surface of the case 12a. Further, the frame 32 has its lower surface positioned lower than the surface of each terminal 31, that is, the frame 32 is shaped like projecting ribs, so as to prevent hands from mistakenly touching the terminals 31.

On both sides of the cover 33, its front part is configured as ribs 33b made independent by slits 33a and having downward protruding engaging parts 33c on their tips.

On the other hand, the window part 12e of the case 12a has ribs 34 protruding inwardly toward each other from the front parts of both sides of the window part 12e. The ribs 34 engage the ribs 33b of the cover 33 to horizontally guide the cover 33. When the cover 33 completely fills in the window part 12e, the engaging parts 33 fit into spaces 35 between the front ends of the ribs 34 and the front ends of the window part 12e so that the cover 33 can be locked.

Next, a description will be given of the USB interface device 11 that is the second embodiment.

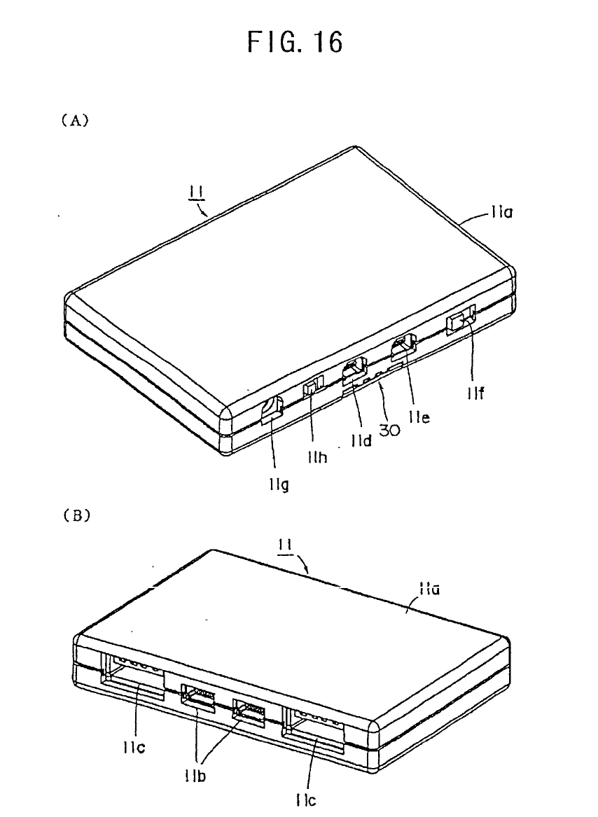

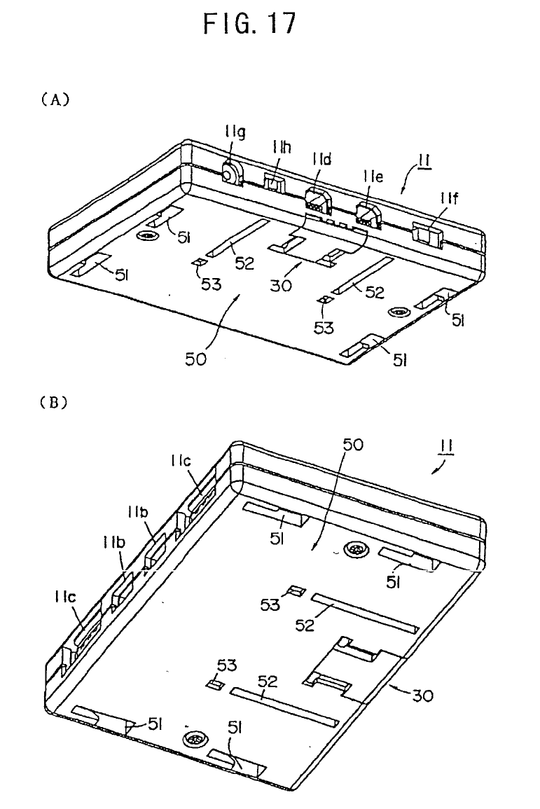

The USB interface device 11 serves as a main USB hub, and as shown in FIGS. 16 and 17, includes a flat rectangular parallelepiped case 11a, and the terminal part 30 and the connection part 50 provided on the lower surface of the case 11a.

A chip-like USB hub circuit is mounted on a substrate (not shown in the drawings) provided inside the case 11a, and two types of USB ports 11b and 11c are provided on the front side of the case 11a. The USB ports 11b and 11c and the terminal part 30 are connected, as lower-side USB ports, to the USB hub circuit.

Two host-side USB ports 11d and 11e are provided on the rear side of the case 11a, and can be switched selectively from one to the other by a changeover switch 11f. Further, a power-supply terminal 11g and a power switch 11h are provided on the rear side of the case 11a. Power is supplied from outside to the power-supply terminal 11g, and is turned on and off by the power switch 11h.

The terminal part 30 and the connection part 50 have the same configurations as those provided to the above-described USB interface device 12 according to the first embodiment, and a description thereof will be omitted.

Next, a description will be given of the USB interface device 13 that is the third embodiment.

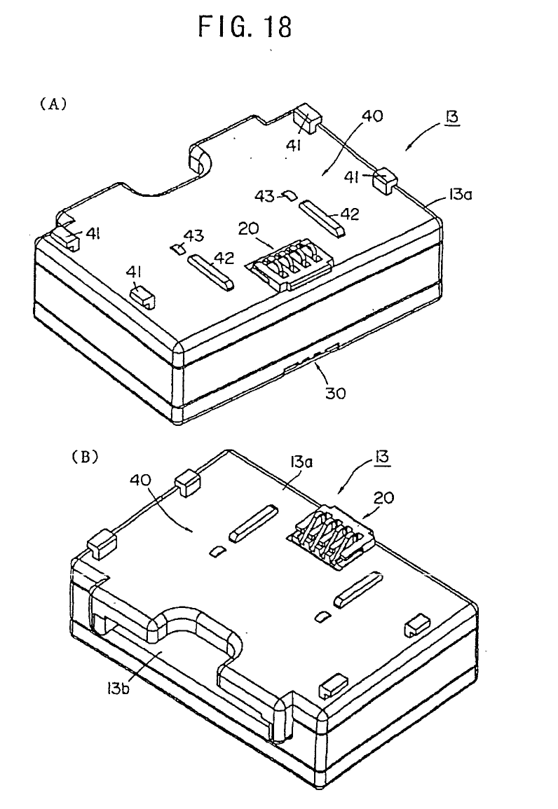

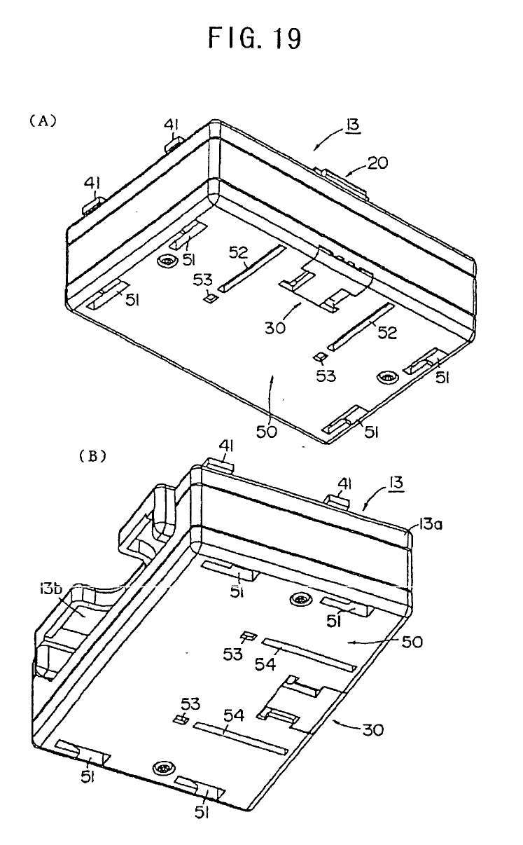

The USB interface device 13 is configured as a compact flash card reader as an auxiliary recording device, and as shown in FIGS. 18 and 19, includes a flat rectangular parallelepiped case 13a, the contact part 20 and the connection part 40 provided on the upper surface of the case 13a, and the terminal part 30 and the connection part 50 provided on the lower surface of the case 13a.

The contact part 20 is connected, as a-so-called host-side USB port, to a chip-like USB hub circuit mounted on an internally provided substrate (not shown in the drawings). Further, an insertion slot 13b for a compact flash card is provided on the front side of the case 13a, and a connector to be connected to the connector part of the compact flash card and a control circuit (not shown in the drawings) are mounted on the substrate in the bottom of the insertion slot 13b. The control circuit and the terminal part 30 are also connected, as lower-side USB ports, to the USB hub circuit.

The contact part 20, the terminal part 30, and the connection parts 40 and 50 have the same configurations as those of the above-described USB interface device 12 according to the first embodiment, and a description thereof will be omitted.

Next, a description will be given of the USB interface device 14 that is the fourth embodiment.

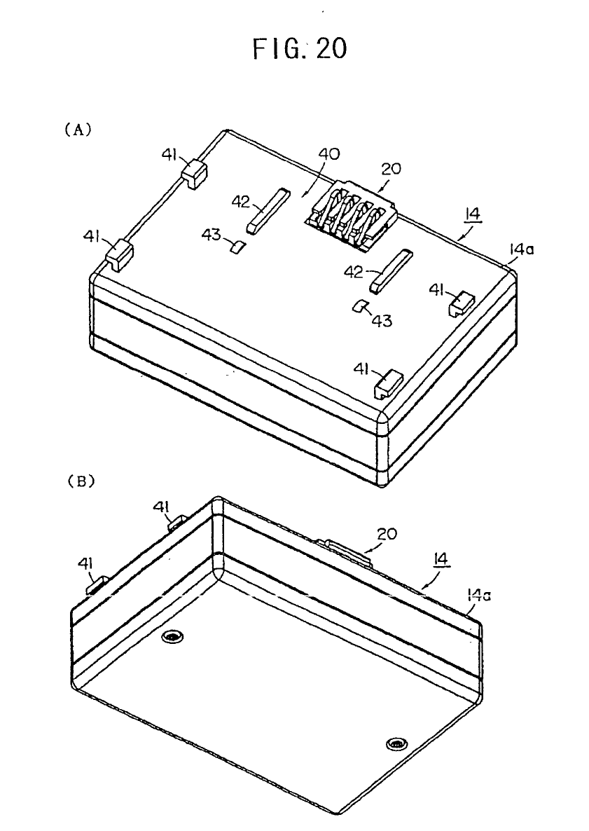

The USB interface device 14 is used as a power unit for supplying the power to the USB interfaces, and as shown in FIG. 20, includes a flat rectangular parallelepiped case 14a, the contact part 20 and the connection part 40 provided on the upper surface of the case 14a, and a power battery and a power circuit (not shown in the drawing) housed inside the case 14a.

The contact part 20 and the connection part 40 have the same configurations as those of the USB interface device 12 according to the first embodiment, and a description thereof will be omitted.

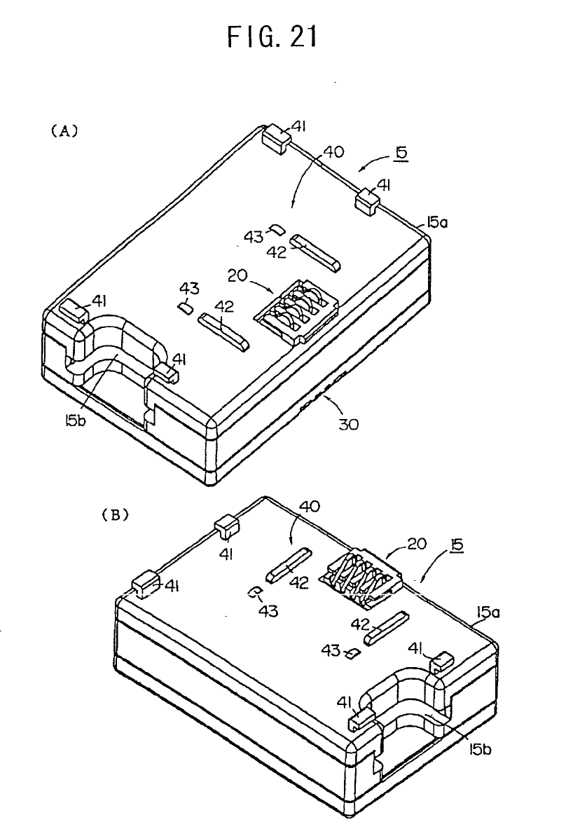

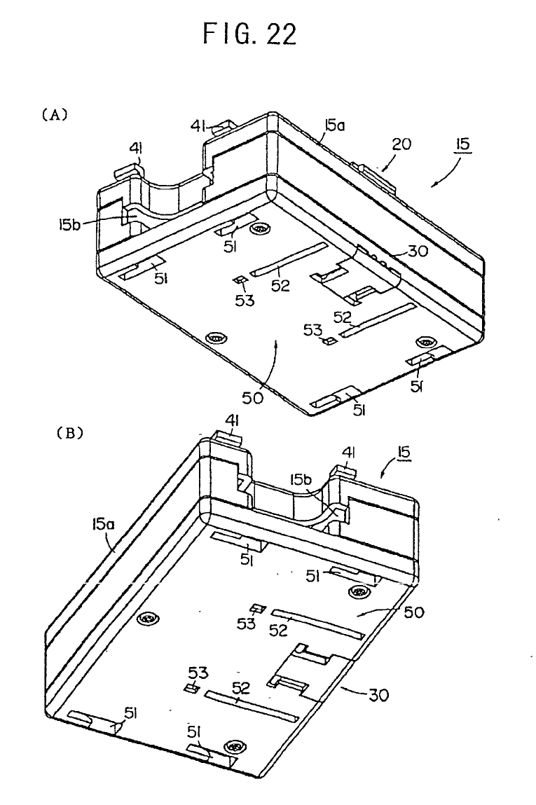

FIGS. 21 and 22 show a variation of the USB interface device 13 according to the third embodiment shown in FIGS. 18 and 19.

In FIGS. 21 and 22, a USB interface device 15 is configured as a memory stick as an auxiliary recording device, and has a flat rectangular parallelepiped case 15a, the contact part 20 and the connection part 40 provided on the upper surface of the case 15a, and the terminal part 30 and the connection part 50 provided on the lower surface of the case 15a.

The contact part 20 is connected, as a so-called host-side USB port, to a chip-like USB hub circuit mounted on an internally provided substrate (not shown in the drawings). Further, an insertion slot 15b for a memory stick is provided on the right side of the case 15a, and a connector to be connected to the connector part of the memory stick and a control circuit (not shown in the drawings) are mounted on the substrate in the bottom of the insertion slot 15b. The control circuit and the terminal part 30 are also connected, as lower-side USB ports, to the USB hub circuit.

The contact part 20, the terminal part 30, and the connection parts 40 and 50 have the same configurations as those of the above-described USB interface device 12 according to the first embodiment, and a description thereof will be omitted.

The USB interface system 10 is composed of the USB interface devices 11 through 14 according to the above-described embodiments. In the case of its use, the multiple USB interfaces 11 through 14 are layered one over the other to be fixed and held as shown in FIG. 4. Here, a description will be given, for instance, of the case of joining the USB interface devices 11 and 12.

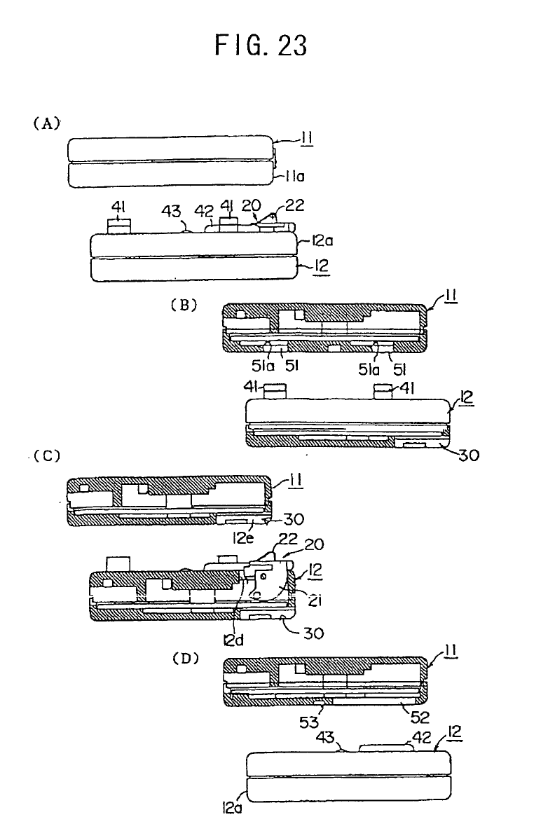

In joining the USB interface devices 11 and 12, first, as shown in FIG. 23, the upper USB interface device 11 is arranged in a position slightly shifted forward with respect to the lower USB interface device 12. At this point, the wider parts of the hook holes 51 provided on the lower surface of the case 11a of the upper USB interface device 11 oppose the hooks 41 provided on the upper surface of the case 12 of the lower USB interface device 12 (see FIGS. 5, 7, and 7).

Next, as shown in FIG. 24(A), the upper USB interface device 11 is moved downward so that the lower surface of the case 11a of the USB interface device 11 comes into contact with the upper surface of the case 12a of the USB interface device 12.

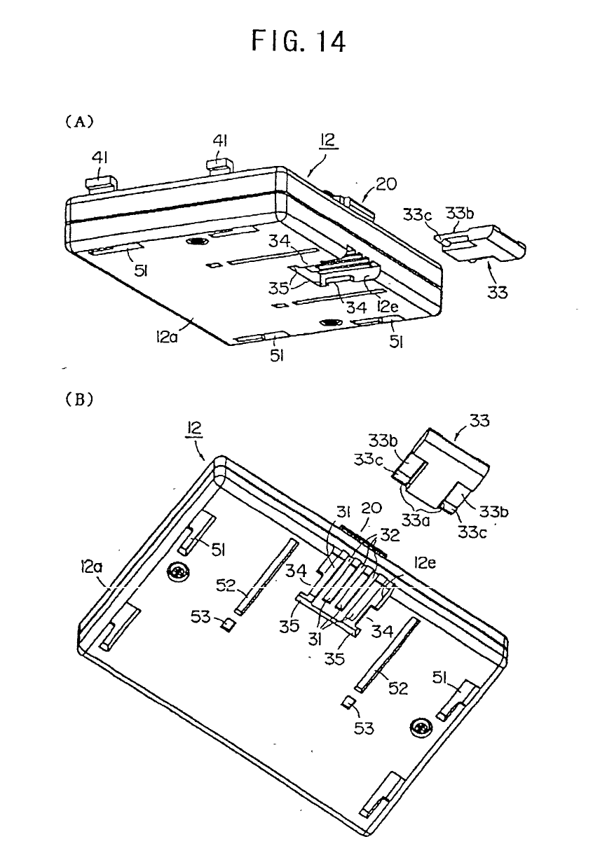

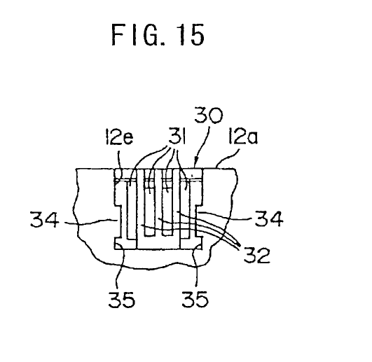

At this point, as shown in FIG. 24(B), the hooks 41 of the USB interface device 12 are inserted into the wider parts of the hook holes 51 of the USB interface device 11, and as shown in FIG. 24(D), the guiding convex parts 42 of the USB interface device 12 are inserted into the guide grooves 52 of the USB interface device 11. Further, as shown in FIG. 24(C), the main body 21 and each contact 22 of the contact part 20 protruding from the upper surface of the case 12a of the USB interface device 12 enter a window part lid (12d) provided on the lower surface of the case 11a of the USB interface device 11, so that each contact 22 comes into contact with the corresponding terminal 31 (see FIGS. 14 and 15) to be pressed downward, thereby elastically deforming as shown in FIG. 9(D) to elastically contact the terminal 31.

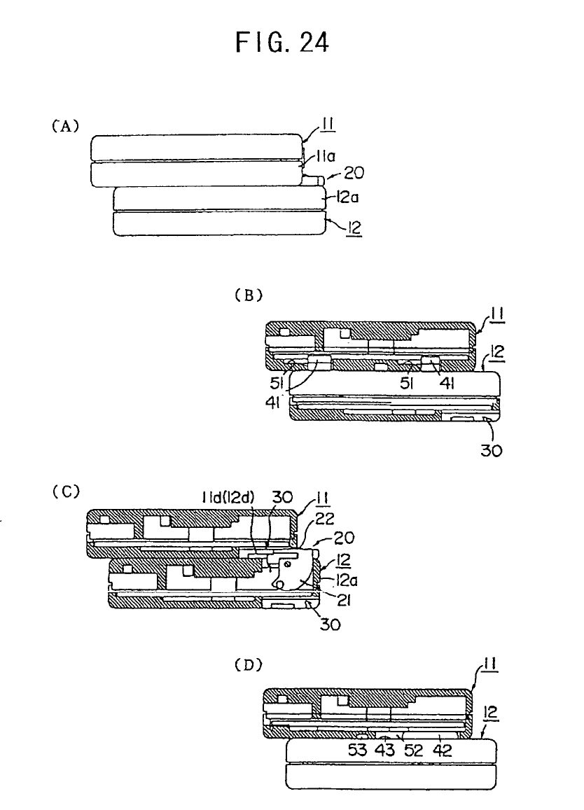

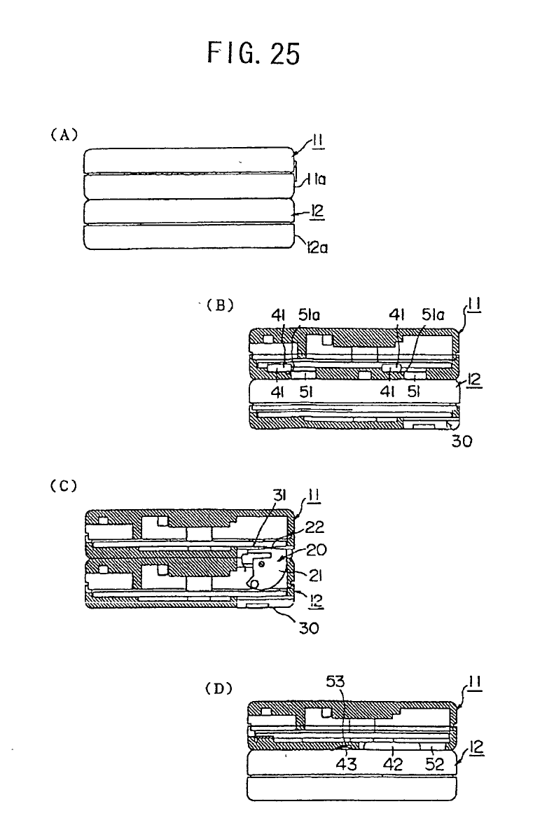

Thereafter, as shown in FIG. 25(A), the USB interface device 11 is shifted backward (rightward in the drawing) with respect to the USB interface device 12, so that the USB interface devices 11 and 12 have their respective cases 11a and 12a aligned.

At this point, the guiding convex parts 52 of the USB interface device 12 are fitted into the guide grooves 42 of the case 11a of the USB interface device 11 so that the case 11a of the USB interface device 11 is prevented from being shifted to a sideward position. Further, the hooks 41 of the USB interface device 12 are shifted inside the hook holes 51 of the USB interface device 11 so that the hook claws 41a of the hooks 41 engage the bottom sides of the narrower parts of the hook holes 51 as shown in FIG. 25(B). Thereby, the cases 11a and 12a are fixed to and held by each other.

The oblique indentations 51a are provided to the hook holes 51 so that the hook claws 41a of the hooks 41 can smoothly engage the bottom sides of the narrower parts of the hook holes 51 when the hooks 41 are shifted inside the hook holes 51.

Further, as shown in FIG. 25(D), the positioning convex parts 43 of the USB interface device 12 fit into the positioning concave parts 53 of the USB interface device 11 so that the cases 11a and 12a are half locked to each other in the front and rear directions.

Here, as shown in FIG. 25(C), the contact part 20 of the USB interface device 12 is positioned to the terminal part 30 with respect to a sideward direction with the ribs 21a projecting to both sides from the main body 21 being engaged with the ribs 34 protruding inwardly toward each other from the window part of the terminal part 30 (see FIGS. 7, 8, and 14). Thereby, the USB interface devices 11 and 12 are completely joined.

The USB interface devices 12, 13, and 14 are successively joined with each other in the same manner so that the USB interface devices 11, 12, 13, and 14 are joined with each other, thereby forming the USB interface system 10. Thus, with respect to the USB interface devices 11, 12, 13, and 14, each pair of the USB interface devices to be joined (layered) can be engaged only by an engagement operation of sliding the paired USB interface devices relative to each other. Therefore, the engagement operation can be simplified.

According to the USB interface system 10 of such a configuration, personal computers are connected via USB cables to the host-side USB ports 11d and 11e of the USB interface device 11 as a main USB hub and a variety of USB-interface peripheral devices such as a keyboard, a mouse, a printer, and a scanner or USB hubs are connected to the lower-side USB ports 11b, 11c, 12c, and 12b of the USB interface devices 11 and 12 so that the peripheral devices can be operated from the personal computers via the USB interfaces.

At this point, the USB interface devices 11, 12, 13, and 14 are directly connected electrically via their respective contact parts 20 and opposing terminal parts 30 with their cases being joined to each other without connection by USB cables. Therefore, the USB cables and space for their connection are dispensed with, thus leading to connection simplification and space reduction.

The USB ports 11d and 11e of the USB interface device 11 can be switched from one to the other by the changeover switch 11f. Therefore, by switching between the two personal computers connected to the USB ports 11d and 11e, respectively, by the changeover switch 11f, the peripheral devices connected by the USB interface system 10 can be operated selectively from both personal computers.

Further, when more USB-interface peripheral devices are used by the USB interface system 10, the personal computers alone do not supply sufficient power. However, by supplying power from the power battery housed in the USB interface device 14, sufficient power may be supplied to the USB-interface peripheral devices connected to the USB interface system 10.

Further, in the USB interface system 10 shown in FIG. 3, the USB interface device 13 may be replaced by the USB interface device 15 of the configuration as a memory stick reader as shown in FIGS. 20 and 21. The USB interface device 15 may also be incorporated between the USB interface devices 13 and 14 or between the USB interface devices 12 and 13, for instance, in the USB interface system 10.

Thus, according to the USB interface devices 11, 12, 13, 14, and 15 of the present invention, the USB-interface peripheral devices may be operated from the personal computers by forming the USB interface system 10 by properly joining the USB interface devices 11 through 15 and USB-connecting the USB-interface peripheral devices to the personal computers via the USB interface system 10. Further, by USB-connecting the USB interface devices 11 through 15 by direction connection without using the USB cables, space for the USB cables is no longer necessary and interconnection lines can be simplified.

Moreover, the contact part 20, when not in use, has the main body 21 rotated about the rotation shaft 23 to be brought down to the contact retraction position so that each contact 22 can be protected without being exposed to outside.

On the other hand, the terminal part 30 has the frame 32 formed by a part of the case between the terminals 31 so that the terminals 31 are prevented from being touched mistakenly by hands at the time of handling. Further, the terminal part 30 has the cover 33 attached to fill in the window part completely so that the terminals 31 inside can be securely protected.

In the above-described embodiments, the keyboard, the mouse, the printer, and the scanner are shown as peripheral devices to be connected to the USB ports 11b, 11c, 12c, and 12b. However, this is not the only case, and it is apparent that other peripheral devices such as a USB-compliant terminal adapter, a CD-R (recordable CD) drive, and a musical instrument are connectable.

Further, in the above-described embodiments, the USB interface devices 11 and 12 are provided with the two different-type USB ports 11b and 11c and the two different-type USB ports 12c and 12b, respectively. However, this is not the only case, and each of the USB interface devices 11 and 12 may be provided with at least one of the USB ports of the two types.

Furthermore, in the above-described embodiments, no USB port is provided to the USB interface devices 13 through 15. However, this is not the only case, and each of the USB interface devices 13 through 15 may have at least one USB port.

Next, a description will be given of a fifth embodiment of the present invention.

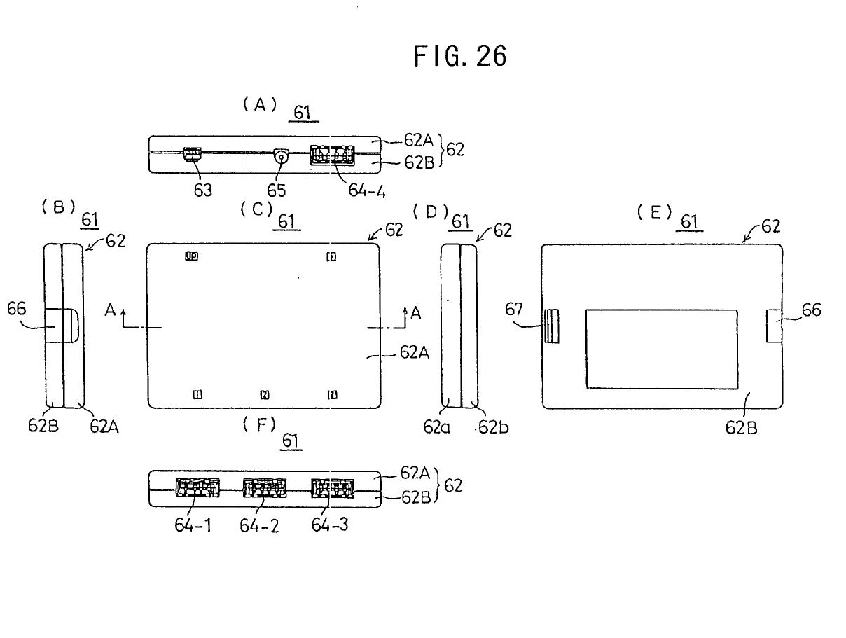

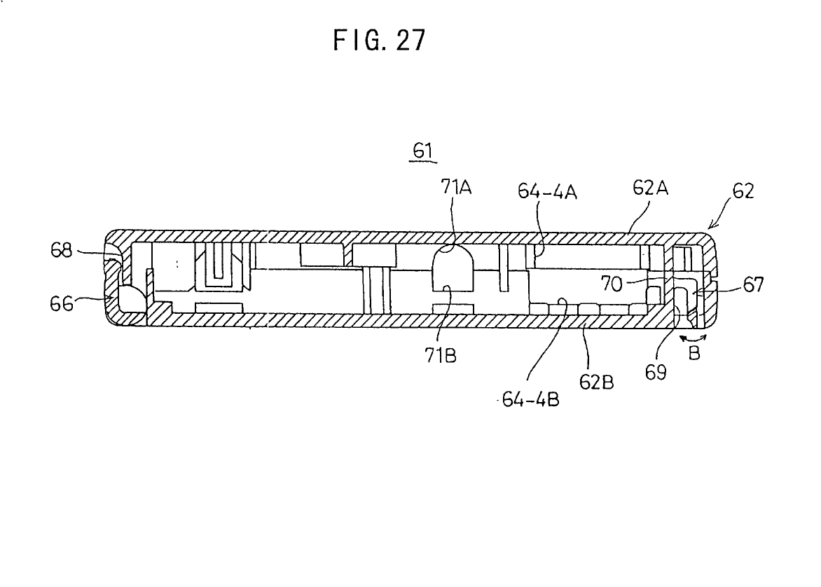

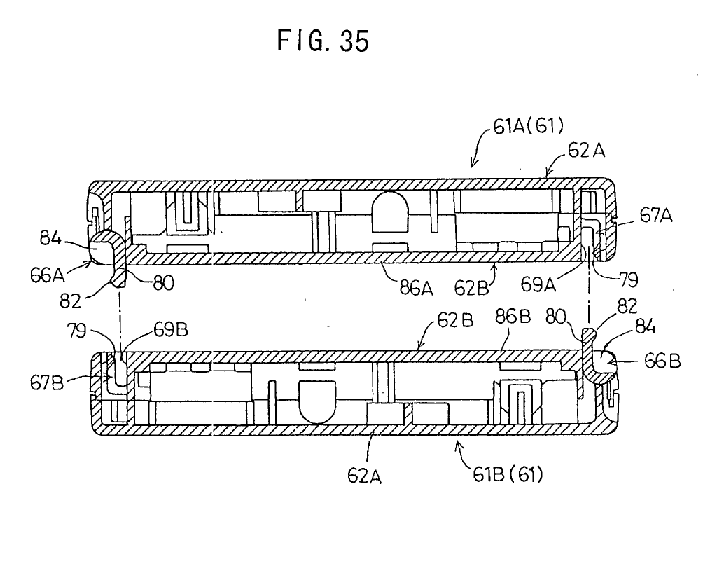

FIGS. 26 and 27 show a USB interface device 61 that is the fifth embodiment. FIG. 26 is a diagram showing six sides of the external appearance of the USB interface device 61, and FIG. 27 is a sectional view of the USB interface device 61 of FIG. 26 taken along the line A-A. Like the above-described embodiments, the USB interface devices 61 according to this embodiment are also layered one over another to be usable as a USB system 60 (see FIGS. 35 through 37).

The USB interface device 61 is composed mainly of a case 62, a host-side USB port 63, lower-side USB ports 64-1A through 64-4A, a power-supply terminal 65, a hook part 66 (corresponding to a convex part described in claims), an engaging part 67, and an insertion concave part (corresponding to a concave part described in claims). The hook part 66 and the insertion concave part 69 (including the engaging part 67) cooperate to form a joining mechanism described in claims.

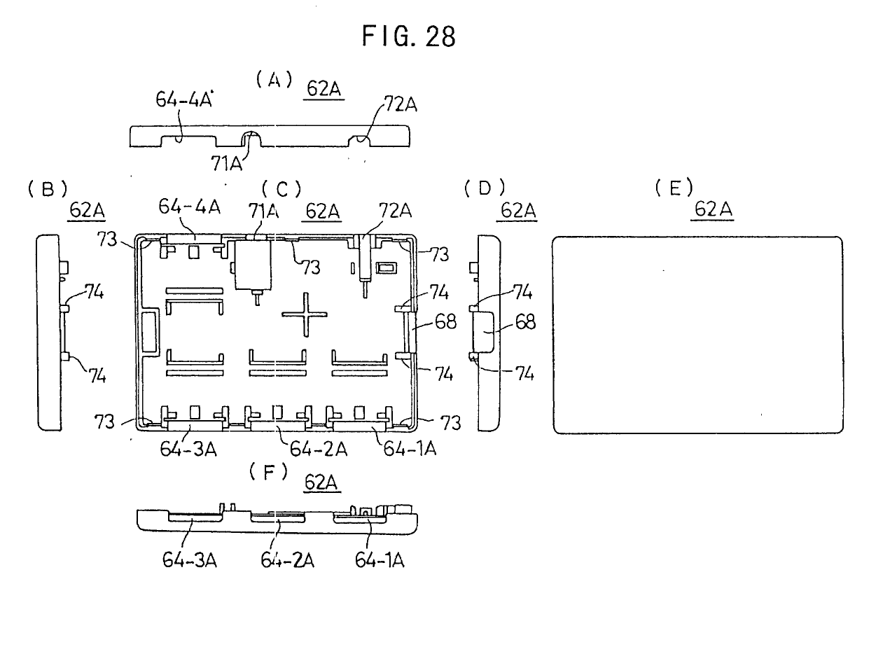

The case 62 is formed of a pair of case half bodies 62A and 62B formed of a resin. As shown in FIG. 28 in addition to FIGS. 26 and 27, the case half body 62A is composed of a housing concave part 68, a variety of concave parts 64-1A through 64-4A, 71A, and 72A, lock claws 73, and shaft holding parts 74. The housing concave part 68 is a concave part for housing the hook part 66 that will be described later in detail, and is formed in the center of one shorter side of the case halt body 62A (see FIG. 28(D)).

The concave parts for port 64-1A through 64-4A are formed so as to correspond to positions where the lower-side USB ports 64-1 through 64-4 are provided. That is, the concave part for port 64-1A is formed in the position where the lower-side USB port 64-1 is provided. Similarly, the concave part for port 64-2A is formed in the position where the lower-side USB port 64-2 is provided, the concave part for port 64-3A is formed in the position where the lower-side USB port 64-3 is provided, and the concave part for port 64-4A is formed in the position where the lower-side USB port 64-4 is provided. Further, the concave part for power-supply terminal 71A is formed in a position where the power-supply terminal 65 is formed, and the concave part for port 72A is formed in a position where the host-side USB port 63 is formed.

The lock claws 73 engage hook claws 76 formed on the later-described case half body 62B. With the hook claws 76 engaging the lock claws 73, the paired case half bodies 62A and 62B are joined to form the case 62.

The shaft holding parts 74 are formed on both sides of the housing concave part 68. The shaft holding part 74 holds shaft parts 81 of the hook part 66 attached rotatably to the case half body 62B as will be later described when the paired case half bodies 62A and 62B are joined. Thereby, smooth rotation of the hook part 66 is realized.

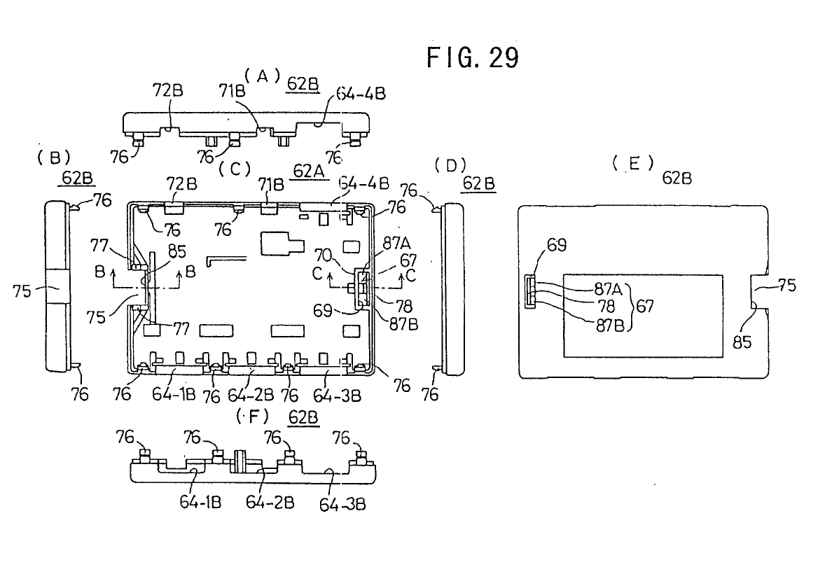

On the other hand, the case half body 62B, as shown in FIG. 29 in addition to FIGS. 26 and 27, is composed of a variety of concave parts 64-1B through 64-4B, 71B, and 72B, the engaging part 87, and a hook part attachment concave part 75, the hook claws 76, and bearing parts 77.

The concave parts for port 64-1B through 64-4B are formed so as to correspond to positions where the lower-side USB ports 64-1 through 64-4 are provided. That is, the concave part for port 64-1B is formed in the position where the lower-side USB port 64-1 is provided. Similarly, the concave part for port 64-2B is formed in the position where the lower-side USB port 64-2 is provided, the concave part for port 64-3B is formed in the position where the lower-side USB port 64-3 is provided, and the concave part for port 64-4B is formed in the position where the lower-side USB port 64-4 is provided. Further, the concave part for power-supply terminal 71B is formed in a position where the power-supply terminal 65 is formed, and the concave part for port 72B is formed in a position where the host-side USB port 63 is formed.

The hook claws 76 are formed to protrude from the case half body 62B to engage the lock claws 73 formed on the case half body 62A.

Thereby, with the lock claws 73 engaging the hook claws 76 as previously described, the paired case half bodies 62A and 62B are joined to form the case 62.

The hook part attachment concave part 75 is a concave part provided for attaching the hook part 66, and is formed in the center of one shorter side of the case half body 62B (see FIGS. 29(B) and 29(C)). With the joined paired case half bodies 62A and 62B forming the case 62, the hook part attachment concave part 75 communicates with the above-described housing concave part 68 of the case half body 62A.

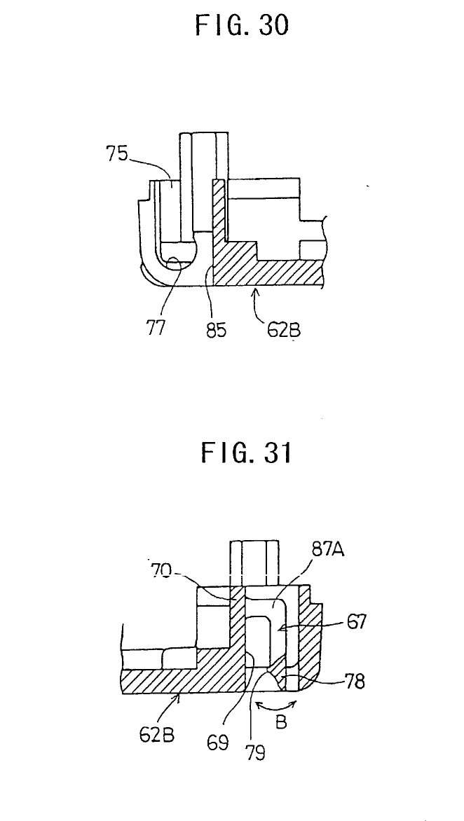

FIG. 30 shows a section taken along the line B-B of FIG. 29(C). As shown in the drawing, the bearing parts 77 receiving the shaft parts 81 of the hook part 66 are formed on both sides of a position where the hook part attachment concave part 75 of the case half body 62B is formed. Thereby, with the shaft parts 81 being received by the bearing parts 77, the hook part 66 is rotatable with respect to the case half body 62B (that is, the case 62).

As previously described, with the paired case half bodies 62A and 62B being joined, the shaft holding parts 74 formed on the case half body 62A hold the shaft parts 81 of the hook part 66. Thereby, the hook part 66 is rotatable with respect to the case 62 without looseness.

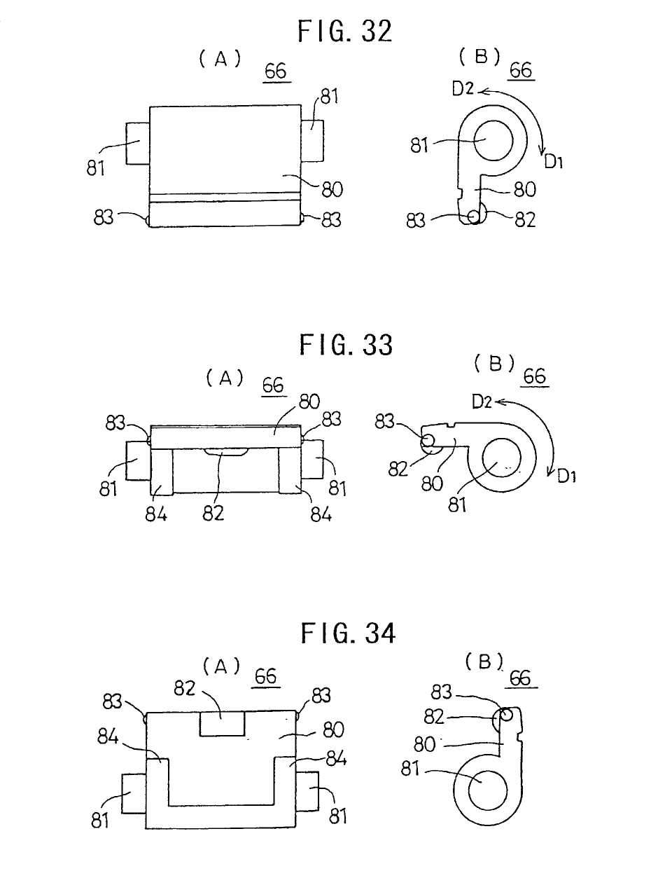

Here, a description will be given, by employing FIGS. 32 through 34, of the hook part 66. The one-piece hook part 66 is formed of a resin, and as shown in FIGS. 32(A) and 32(B), is composed of a hook part main body 80, the shaft parts 81, and a projection part 82.

The hook part main body 80 is shaped like a flat plate and has shaft flanges 84 formed on both sides thereof. The shaft parts 81 are formed to protrude outwardly from the shaft flanges 84. Further, the projection part 82 is formed on the inside (the right side in the FIG. 32(B)) of the hook part main body 80. Thereby, the hook part main body 80 is formed to have a hook-like shape. Further, ribs 83 are formed on both sides of the hook part main body 80.

The hook part 66 is attached to the hook part attachment concave part 75 of the case half body 62B as previously described. At this point, the shaft parts 81 are received by the bearing parts 77 formed on both sides of the hook part attachment concave part 75. Thereby, the hook part 66 is rotatable in directions indicated by arrows D1 and D2 in each diagram.

FIG. 32 shows a state where the hook part 66 is rotated to the limit in the direction indicated by arrow D2 in the drawing. This state is the state of the hook part 66 shown in FIGS. 26 and 27, where the hook part main body 80 is housed in the hook part attachment concave part 75 formed in the case half body 62A (hereinafter, the position of the hook part 66 shown in FIGS. 26, 27, and 32 is referred to as a housed position).

When the hook part 66 is rotated in the direction indicated by arrow D1 from the state shown in FIG. 32, the hook part 66 passes a position shown in FIG. 33 (a position rotated 90° from the housed position) to be in a state shown in FIG. 34. FIG. 34 shows the state where the hook part 66 is rotated 180° from the housed position. In this state, the hook part main body 80 contacts an inner wall 85 (see FIGS. 29(C) and 29(E)) of the hook part attachment concave part 75 so that further rotation of the hook part main body 80 is restricted.

The state where the hook part 66 is thus rotated 180° from the housed position is a state shown in FIGS. 35 through 37. In this state, the hook part main bodies 80 of the hook parts 66 protrude from the case surfaces 86A and 86B of the case half bodies 62 (62A and 62B) (hereinafter, the position of the hook part 66 shown in FIGS. 34 through 37 is referred to as a protruding position).

Here, referring back again to FIG. 29, the description of the case half body 62B is continued. In addition to the above-described configuration, the case half body 62B is further provided with the engaging part 67 and the insertion concave part 69. The insertion concave part 69 and the hook part attachment concave part 75 (that is, the hook part 66) are provided in symmetrical positions with respect to the center position of the case half body 62B. Specifically, the insertion concave part 69 is formed in the center position of a shorter side of the case half body 62A which shorter side is different from that on which the hook part attachment concave part 75 is formed.

The engaging part 67 is formed to protrude inside the insertion concave part 69 formed in the case half body 62B. As will be described later, the insertion concave part 69 is a part into which the hook part 66 in the protruding position is inserted.

The engaging part 67 is formed of a pair of arm parts 87A and 87B and a connection part 78 that connects end parts of the arm parts 87A and 87B. FIG. 31 is an enlarged sectional view of the engaging part 67 of FIG. 29(C) taken along the line C-C. As shown in the drawing, an end part of the arm part 87A (the arm part 87B is not shown in FIG. 31), which end part is different from that on which the connection part 78 is formed, is integrally connected to a rib 70 formed on the case half body 62B.

Thereby, the engaging part 67 is flexible in directions indicated by arrow B in the drawing with respect to the rib 70. Further, a projection part 79 protruding inward is formed integrally with the communication part 78. The engaging part 67 of the above-described configuration is positioned inside the insertion concave part 69 when viewed from the backside of the case half body 62B (see FIG. 29(E)).

Next, a description will be given of a procedure for forming the USB system 60 by layering the USB interface devices 61 of the above-described structure one over another.

The USB interface devices 61 according to this embodiment can be used as single devices and also as the USB system 60 by being layered one over another. In the case of using the USB interface device 61 as a single device, the hook part 66 is placed in the housed position by being rotated to the limit in the direction indicated by arrow D2 as shown in FIG. 32.

Thereby, as shown in FIGS. 26 and 27, the hook part 66 is housed in the housing concave part 68 without protruding from the case 62. Therefore, in the case of carrying the USB interface device 61, the portability thereof is increased. With the hook part 66 being in the housed position, the ribs 83 formed on both sides of the hook part main body 80 are pressed to come into contact with the inner wall of the hook part attachment concave part 75. Thereby, the hook part 66 is prevented from moving from the housed position at the time of carrying the USB interface device 61. This also increases the portability of the USB interface device 61.

Further, in the case of using the USB interface device 61 on a desk, a cable connected to the USB interface device 61 is prevented from catching the hook part 66. Furthermore, since the engaging part 67 is positioned inside the insertion concave part 69 as previously described, the engaging part 67 is prevented from protruding from the case 62. Therefore, for the same reason as described above, the portability is increased and the cable is prevented from catching the engaging part 67.

In this embodiment, the hook part 66 is moved between the protruding and housed positions by being made rotatable with respect to the case 62. The hook part may also be formed to be linearly movable with respect to the case 62. However, in the case of moving the hook part linearly, a broader space is required for the movement of the hook part with poorer operability than in this embodiment. On the other hand, by forming the hook part 66 to be rotatable with respect to the case 62 as in this embodiment, a smaller space is required for the movement of the hook part 66, thus realizing the downsized USB interface device 61 and enabling an operation of moving the hook part 66 to be performed with ease.

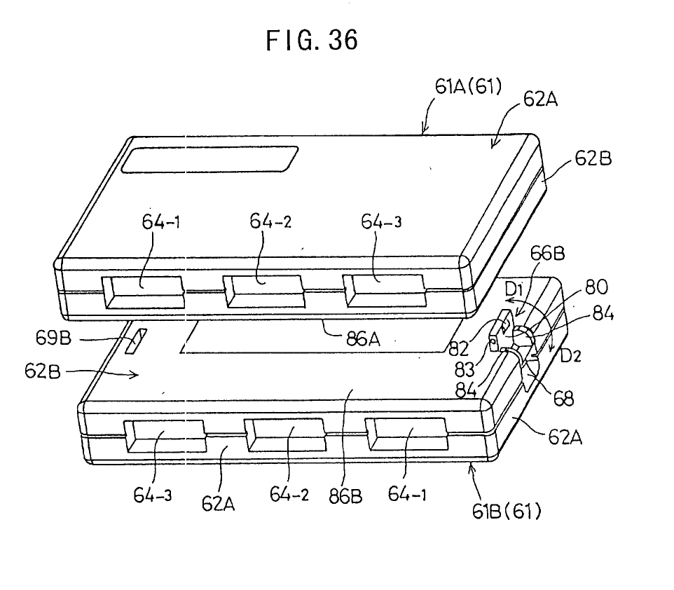

On the other hand, in the case of using the layered USB interface devices 61 as the USB system 60, first, the hook part 66 of each of the paired USB interface devices 61 to be layered one over the other is rotated to the protruding position, and the paired USB interface devices 61 are arranged as shown in FIGS. 35 and 36.

For convenience of description and graphical representation, the USB interface device 61 in an upper position in FIGS. 35 through 37 and its main components will be described with “A” being attached to their numerals, and the USB interface device 61 in a lower position in FIGS. 35 through 37 and its main components will be described with “B” being attached to their numerals.

In layering the paired USB interface devices 61A and 61B one over the other, with respect to the USB interface device 61A, the other USB interface device 61B is reversed (turned upside down). The USB interface device 61A has both hook part 66A and insertion concave part 69A provided on the case surface 86A, and the USE interface device 61B has both hook part 66B and insertion concave part 69B provided on the case surface 86B. Further, on the case surface 86A, the hook part 66A and the insertion concave part 69A are provided in the symmetrical positions with respect to the center of the case surface 86A, and on the case surface 86B, the hook part 66B and the insertion concave part 69B are provided in the symmetrical positions with respect to the center of the case surface 86B.

Therefore, by only reversing the USE interface device 61A with respect to the other USB interface device 61B, the case surfaces 86A and 86B oppose each other so that the hook part 66A of the USB interface device 61A opposes the insertion concave part 69B of the case half body 62B and the insertion concave part 69A of the USB interface device 61A opposes the hook part 66B of the case half body 62B (see FIG. 35).

Next, the USB interface devices 61A and 61B are relatively layered one over the other. Thereby, the hook part main body 80 of the hook part 66A protruding from the case surface 86A (the case half body 62B) of the USB interface device 61A is inserted into the insertion concave part 69B provided in the USB interface device 61B. Likewise, the hook part main body 80 of the hook part 66B protruding from the case surface 86B (the case half body 62B) of the USB interface device 61B is inserted into the insertion concave part 69A provided in the USB interface device 61A.

As previously described, the engaging parts 67A and 67 are formed inside the insertion concave parts 69A and 69 to extend like tongue pieces, and are flexible in the directions indicated by arrow B in FIG. 31. Further, the projection parts 79 protruding inward are formed on the connection parts 78 forming the engaging parts 67A and 67.

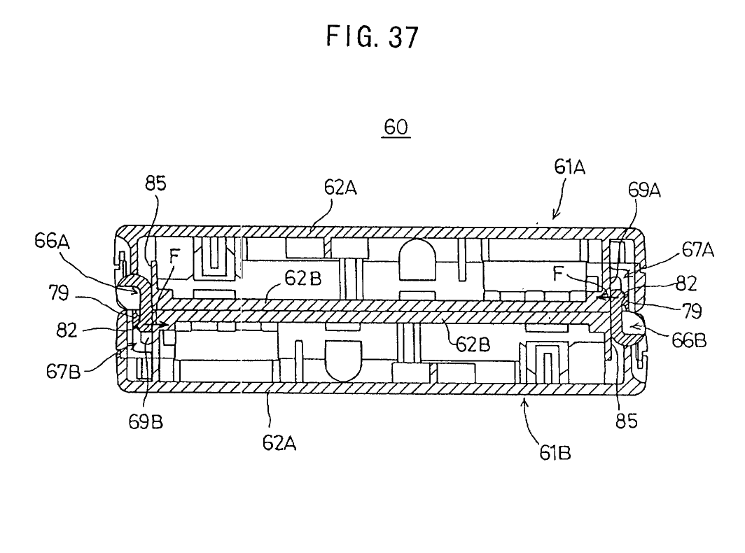

Therefore, by inserting the hook part main body 80 of the hook part 66A shaped like a hook by having the projection part 82 into the insertion concave part 69B, the projection part 82 engages the projection part 79 of the engaging part 67B. Likewise, by inserting the hook part main body 80 of the hook part 66B shaped like a hook into the insertion concave part 69A, the projection part 82 engages the projection part 79 of the engaging part 67A. Thereby, as shown in FIG. 37, the USB interface devices 61A and 61B are joined to form the USB system 60.

The projection parts 79 and 82 engage each other with the USB interface devices 61A and 61B being joined. Therefore, joining forces between the projection parts 79 and 82 are great so that the USB interface devices 61A and 61B can be maintained in a securely layered state.

In this embodiment, the projection parts 82 protrude from the hook part main bodies 80 toward the outside of the cases 62. Therefore, with the hook part main bodies 80 being inserted into the insertion concave parts 69A and 69B, forces directed inward (forces indicated by arrows F in FIG. 37) are generated inside the hook part main bodies 80. These forces F are exerted as forces pressing the hook part main bodies 80 onto the inner walls 85 of the hook part attachment concave parts 75, thus preventing the hook parts 66A and 66B from falling to the housed positions at the time of their engagement.

As described above, the USB interface devices 61A and 61B can be layered one over the other to form the USB system 60 with a simple configuration in this embodiment. By thus layering the USB interface devices 61A and 61B one over the other, as in the above-described embodiments, space reduction can be realized and interconnection lines can be simplified with efficiency to be connected to the USB interface devices 61A and 61B compared with a configuration where the USB interface devices are provided in a planar arrangement. Further, compared with a configuration where USB interface devices are simply layered one over another without any joining mechanisms (the hook parts 66A and 66B and the insertion concave parts 69A and 69B), the USB interface devices 61A and 61B are prevented from having a deviation between their positions.

In the USB system 60 shown in FIG. 37, electrical connection between the USB interface devices 61A and 61B is established by connecting the lower-side USB ports 64-4 provided in the USB interface devices 61A and 61B by a USB cable.

Although the description has been given by taking the USB interface device as an example in each of the above-described embodiments, the present invention is applicable not only to the USB interface device, but also to a variety of electronic devices that are used in a layered structure.

As previously described, according to the present invention, electronic devices (USB interface devices) are layered one over another without using a cable with the contact part provided in one electronic devices (a USB interface devices) and the opposing contact part provided in an electronic device (a USB interface device) adjacent thereto being directly connected. Therefore, space for cables for connection can be dispensed with and interconnection lines can be simplified.

Further, one electronic device and another electronic device can be joined in a layered state with a simple configuration by forming a joining mechanism that mechanically joins a plurality of electronic devices of a convex part provided to the case of the one electronic device and a concave part provided on the surface of the case of the other electronic device which surface opposes, when the other electronic device is layered on the one electronic device, the surface of the case of the one electronic device on which surface the convex part is provided so that the one electronic device and the other electronic device are mechanically joined with the convex part engaging the concave part. Furthermore, space reduction can be realized compared with a configuration where a plurality of electronic devices are provided in a planar arrangement. Moreover, compared with a simple configuration of layered electronic devices, the electronic devices are prevented from having a deviation between their positions.

The present invention is not limited to the specifically disclosed embodiments, but variations and embodiments may be made without departing from the claimed scope of the present invention.

1. A connector device for an electronic device electrically connecting a plurality of electronic devices when the electronic devices are layered one over another, the connector device for an electronic device comprising:
a first-type connector provided to a first surface of a case of each of the electronic devices;
a second-type connector provided in a position on a second surface opposing the first surface, the position corresponding to a position in which the first-type connector is provided,
wherein at least one of the first-type and second-type connectors provided to one of the layered electronic devices is connected to the connector provided to another one of the layered electronic devices when the electronic devices are layered one over another, the connector being of a type different from that of the one of the first-type and second-type connectors.

2. A USB interface device comprising:
a first-type connector provided to a first surface of a case, a second-type connector provided to a second surface of the case opposing the first surface, and a USB hub circuit provided in the case so as to connect the connectors,
wherein the first-type and second-type connectors are connectable to each other, and the first-type connector of the USB interface device is connected to the second-type connector of another USB interface device and the second-type connector of the USB interface device is connected to the first-type connector of yet another USB interface device when a plurality of USB interface devices are layered one over another for connection.

3. A USB interface device comprising:
a first-type connector provided to a first surface of a case and a USB device part connected to the first-type connector,
wherein the first-type connector of the USB interface device is connected to a second-type connector of another USB interface device when the other USB interface device is layered on the first surface for connection.

4. A USB interface device comprising:
a second-type connector provided to a second surface of a case, a host-side USB port provided in the case, and a USB hub circuit provided in the case so as to connect the connector and the USB port,
wherein the second-type connector and a first-type connector provided to a first surface of a case of another USB interface device are connectable to each other; and
the second-type connector of the USB interface device is connected to the first-type connector of the other USB interface device when the other USB interface device is layered on the second surface for connection.

5. A connector device for an electronic device electrically connecting a plurality of electronic devices when the electronic devices are layered one over another, the connector device for an electronic device comprising:
a first-type connector provided to a first surface of a case of each of the electronic devices; and
a second-type connector provided in a position on a second surface opposing the first surface, the position corresponding to a position in which the first-type connector is provided,
wherein at least one of the first-type and second-type connectors provided to one of the layered electronic devices is connected to the connector provided to another one of the layered electronic devices when the electronic devices are layered one over another, the connector being of a type different from that of the one of the first-type and second-type connectors;
the first-type connector is a terminal part formed on a substrate provided in the case and exposed in a window part provided to the first surface of the case;
the second-type connector is a contact part protruding from the second surface of the case; and
the terminal part and the contact part come into contact with each other at a time of connection so as to be electrically connected.

6. A USB interface device comprising:
a first-type connector provided to a first surface of a case, a second-type connector provided to a second surface of the case opposing the first surface, and a USB hub circuit provided in the case so as to connect the connectors,
wherein the first-type and second-type connectors are connectable to each other, and the first-type connector of the USB interface device is connected to the second-type connector of another USB interface device and the second-type connector of the USB interface device is connected to the first-type connector of yet another USB interface device when a plurality of USB interface devices are layered one over another for connection;
the first-type connector is a terminal part formed on a substrate provided in the case and exposed in a window part provided to the first surface of the case;
the second-type connector is a contact part protruding from the second surface of the case; and
the terminal part and the contact part come into contact with each other at a time of connection so as to be electrically connected.

7. A USB interface device including a first-type connector provided to a first surface of a case and a USB device part connected to the first-type connector,
and having the first-type connector connected to a second-type connector of another USB interface device when the other USB interface device is layered on the first surface for connection,
wherein the first-type connector is a terminal part formed on a substrate provided in the case and exposed in a window part provided to the first surface of the case;
the second-type connector is a contact part protruding from the second surface of the case; and
the terminal part and the contact part come into contact with each other at a time of connection so as to be electrically connected.

8. A USB interface device comprising:
a second-type connector provided to a second surface of a case, a host-side USB port provided in the case, and a USB hub circuit provided in the case so as to connect the connector and the USB port,
wherein the second-type connector and a first-type connector provided to a first surface of a case of another USB interface device are connectable to each other;
the second-type connector of the USB interface device is connected to the first-type connector of the other USB interface device when the other USB interface device is layered on the second surface for connection;
the first-type connector is a terminal part formed on a substrate provided in the case and exposed in a window part provided to the first surface of the case;
the second-type connector is a contact part protruding from the second surface of the case; and
the terminal part and the contact part come into contact with each other at a time of connection so as to be electrically connected.

9. A connector device for an electronic device electrically connecting a plurality of electronic devices when the electronic devices are layered one over another, the connector device for an electronic device comprising:
a first-type connector provided to a first surface of a case of each of the electronic devices; and
a second-type connector provided in a position on a second surface opposing the first surface, the position corresponding to a position in which the first-type connector is provided,
wherein at least one of the first-type and second-type connectors provided to one of the layered electronic devices is connected to the connector provided to another one of the layered electronic devices when the electronic devices are layered one over another, the connector being of a type different from that of the one of the first-type and second-type connectors;
the connector device for an electronic device

10. A USB interface device comprising:
a first-type connector provided to a first surface of a case, a second-type connector provided to a second surface of the case opposing the first surface, and a USB hub circuit provided in the case so as to connect the connectors,
wherein the first-type and second-type connectors are connectable to each other, and the first-type connector of the USB interface device is connected to the second-type connector of another USB interface device and the second-type connector of the USB interface device is connected to the first-type connector of yet another USB interface device when a plurality of USB interface devices are layered one over another for connection;

11. A USB interface device including a first-type connector provided to a first surface of a case and a USB device part connected to the first-type connector,
and having the first-type connector connected to a second-type connector of another USB interface device when the other USB interface device is layered on the first surface for connection,

12. A USB interface device comprising:
a second-type connector provided to a second surface of a case, a host-side USB port provided in the case, and a USB hub circuit provided in the case so as to connect the connector and the USB port,
wherein the second-type connector and a first-type connector provided to a first surface of a case of another USB interface device are connectable to each other;
the second-type connector of the USB interface device is connected to the first-type connector of the other USB interface device when the other USB interface device is layered on the second surface for connection;

13. The connector device for an electronic device as claimed in claim 5, further comprising:
rib holders provided on both sides of the window part exposing the terminal part, the rib holders protruding inwardly toward each other; and
ribs provided on both sides of the contact part, the ribs protruding outwardly,
wherein the ribs engage the rib holders so that the terminal part and the contact part are positioned relative to each other.

14. The USB interface device as claimed in claim 6, further comprising:
rib holders provided on both sides of the window part exposing the terminal part, the rib holders protruding inwardly toward each other; and
ribs provided on both sides of the contact part, the ribs protruding outwardly,
wherein the ribs engage the rib holders so that the terminal part and the contact part are positioned relative to each other.

15. The USB interface device as claimed in claim 7, further comprising:
rib holders provided on both sides of the window part exposing the terminal part, the rib holders protruding inwardly toward each other; and
ribs provided on both sides of the contact part, the ribs protruding outwardly,
wherein the ribs engage the rib holders so that the terminal part and the contact part are positioned relative to each other.

16. The USB interface device as claimed in claim 8, further comprising:
rib holders provided on both sides of the window part exposing the terminal part, the rib holders protruding inwardly toward each other; and
ribs provided on both sides of the contact part, the ribs protruding outwardly,
wherein the ribs engage the rib holders so that the terminal part and the contact part are positioned relative to each other.

17. The USB interface device as claimed in claim 9, further comprising:
rib holders provided on both sides of the window part exposing the terminal part, the rib holders protruding inwardly toward each other; and
ribs provided on both sides of the contact part, the ribs protruding outwardly,
wherein the ribs engage the rib holders so that the terminal part and the contact part are positioned relative to each other.

18. The USB interface device as claimed in claim 10, further comprising:
rib holders provided on both sides of the window part exposing the terminal part, the rib holders protruding inwardly toward each other; and
ribs provided on both sides of the contact part, the ribs protruding outwardly,
wherein the ribs engage the rib holders so that the terminal part and the contact part are positioned relative to each other.

19. The USB interface device as claimed in claim 11, further comprising:
rib holders provided on both sides of the window part exposing the terminal part, the rib holders protruding inwardly toward each other; and
ribs provided on both sides of the contact part, the ribs protruding outwardly,
wherein the ribs engage the rib holders so that the terminal part and the contact part are positioned relative to each other.

20. The USB interface device as claimed in claim 12, further comprising:
rib holders provided on both sides of the window part exposing the terminal part, the rib holders protruding inwardly toward each other; and
ribs provided on both sides of the contact part, the ribs protruding outwardly,
wherein the ribs engage the rib holders so that the terminal part and the contact part are positioned relative to each other.

21. The USB interface device as claimed in claim 2, wherein:
the contact part is supported rotatably with respect to the case; and
the contact part is rotated with respect to the case to be housed therein when the contact part is unused.

22. The USB interface device as claimed in claim 3, wherein:
the contact part is supported rotatably with respect to the case; and
the contact part is rotated with respect to the case to be housed therein when the contact part is unused.

23. The USB interface device as claimed in claim 4, wherein:
the contact part is supported rotatably with respect to the case; and
the contact part is rotated with respect to the case to be housed therein when the contact part is unused.

24. The USB interface device as claimed in claim 2, further comprising:
an engaging concave part or an engaging convex part provided to the second surface having the second-type connector; and
an engaging convex part or an engaging concave part provided to the second surface having the second-type connector,
wherein the engaging convex part engages the engaging concave part at a time of connection.

25. The USB interface device as claimed in claim 3, further comprising:
an engaging concave part or an engaging convex part provided to the first surface having the first-type connector; and
an engaging convex part or an engaging concave part provided to the second surface having the second-type connector,
wherein the engaging convex part engages the engaging concave part at a time of connection.

26. The USB interface device as claimed in claim 4, further comprising:
an engaging concave part or an engaging convex part provided to the first surface having the first-type connector; and
an engaging convex part or an engaging concave part provided to the second surface having the second-type connector,
wherein the engaging convex part engages the engaging concave part at a time of connection.

27. An electronic device with a joining mechanism mechanically joining a plurality of electronic devices when the electronic devices are layered one over another, wherein:
the joining mechanism comprises:
a convex part provided to a case of one of the electronic devices; and
a concave part provided to a surface of a case of another one of the electronic devices, the surface opposing a surface of the case of the one of the electronic devices to which surface the concave part is provided when the other one of the electronic devices is layered on the one of the electronic devices, the concave part engaging the convex part to mechanically join the one and the other one of the electronic devices.

28. An electronic device with a joining mechanism mechanically joining a plurality of electronic devices when the electronic devices are layered one over another, wherein:
the joining mechanism comprises:
a convex part provided to a case of one of the electronic devices; and
a concave part provided to a surface of a case of another one of the electronic devices, the surface opposing a surface of the case of the one of the electronic devices to which surface the concave part is provided when the other one of the electronic devices is layered on the one of the electronic devices, the concave part engaging the convex part to mechanically join the one and the other one of the electronic devices; and
the convex part and the concave part are provided on a surface of a case of the electronic device in symmetrical positions with respect to a center position of the surface of the case.

29. The electronic device with the joining mechanism as claimed in claim 27, wherein:
the convex part is movable with respect to a case of the electronic device and is moved between a protruding position at which the convex part protrudes from a surface of the case and a housed position at which the convex part is housed without protruding from the surface of the case.

30. The electronic device with the joining mechanism as claimed in claim 28, wherein:
the convex part is movable with respect to the case of the electronic device and is moved between a protruding position at which the convex part protrudes from the surface of the case and a housed position at which the convex part is housed without protruding from the surface of the case.

31. The electronic device with the joining mechanism as claimed in claim 27, wherein:
the convex part engages the concave part by sliding the one of the electronic devices relative to the other one of the electronic devices.

32. The electronic device with the joining mechanism as claimed in claim 28, wherein:
the convex part engages the concave part by sliding the one of the electronic devices relative to the other one of the electronic devices.
